(19) United States
(12) Patent Application Publication
(10) Pub. No.: US 2014/0198531 A1
(43) Pub. Date: Jul. 17, 2014

(54) LIGHT GUIDE PLATE

(71) Applicant: FUJIFILM Corporation, Tokyo (JP)

(72) Inventor: Osamu IWASAKI, Ashigara-kami-gun (JP)

(73) Assignee: FUJIFILM CORPORATION, Tokyo (JP)

(21) Appl. No.: 14/217,754

(22) Filed: Mar. 18, 2014

Related U.S. Application Data
(63) Continuation of application No. PCT/JP2012/071824, filed on Aug. 29, 2012.

(30) Foreign Application Priority Data
Sep. 27, 2011 (JP) 2011-210680

(51) Int. Cl. F21V 8/00

(52) U.S. Cl. CPC G02B 6/0016
USPC 362/621

(57) ABSTRACT

The light guide plate includes two layers having different particle concentrations, in which the thicknesses of the two layers are varied to change the combined particle concentration of the light guide plate, and conditional expressions of 0.3 mm≦T_{lg}≦4 mm and 0.3≦t_{cen}/T_{lg}≦1 are satisfied when the thickness in the direction perpendicular to the light exit surface is defined as T_{lg} and the thickness at the center of the second layer is defined as T_{cen}. The light guide plate of the present invention can have a large and thin shape, can emit light having high light use efficiency and small luminance unevenness, can obtain a middle-high or bell-shaped brightness distribution and can be easily manufactured.

### CROSS REFERENCE TO RELATED APPLICATIONS

This application is a continuation application of International Application PCT/JP2012/071824 filed on Aug. 29, 2012, which claims priority under 35 U.S.C. 119(a) to Application No. 2011-210680 filed in Japan on Sep. 27, 2011, all of which are hereby expressly incorporated by reference into the present application.

### BACKGROUND OF THE INVENTION

The present invention relates to a light guide plate used in a liquid crystal display or the like.

A liquid crystal display uses a planar lighting device (a backlight unit) which illuminates a liquid crystal display panel by irradiation with light from the back side of the liquid crystal display panel. The backlight unit is configured using a light guide plate for diffusing light emitted from an illumination light source to illuminate the liquid crystal display panel and parts such as a prism sheet and a diffusion sheet for making outgoing light from the light guide plate uniform.

Currently, large-size liquid crystal televisions predominantly use a so-called underneath type backlight unit including a light guide plate disposed immediately above an illumination light source. This type of backlight unit ensures uniform light intensity distribution and necessary luminance by disposing a plurality of cold cathode tubes used as light sources behind the liquid crystal display panel and providing the inside of the backlight unit with white reflection surfaces.

However, the underneath type backlight unit requires a thickness of about 30 mm in a direction perpendicular to the liquid crystal display panel in order to make the light intensity distribution uniform, and accordingly, further reduction in thickness is difficult to achieve.

On the other hand, an exemplary backlight unit that allows the thickness reduction includes an edge light type backlight unit using a light guide plate which guides light, which is emitted from an illumination light source and caused to enter from a surface, in predetermined directions, and emits the guided light through a light exit surface that is different from the surface through which the light is caused to enter.

As such an edge light type backlight unit, a backlight unit using a panel-like light guide plate has been proposed in which scattering particles for scattering light are dispersed in a transparent resin.

For example, JP 07-036037 A (Patent Document 1) discloses a light-scattering light-guide light source device which includes a light-scattering light guide member, which has at least one light incidence surface region and at least one light exit surface region, and light source means for causing light to be incident from the light incidence surface region of the light-scattering light guide member. In the light source device, the light-scattering light guide member has a region in which the thickness thereof tends to decrease as it goes farther away from a light incidence surface.

In such an edge light type backlight unit, since a direction in which light is incident on a light incidence surface is different from a direction in which light exits from a light exit surface, there is a tendency that light use efficiency is lower than that of an underneath type and a distribution of outgoing light is uneven. Further, when a light guide plate decreases in thickness and increases in size, it is difficult to guide incident light to a deep side of the light guide plate. In addition, since the area of the light incidence surface is smaller than that of the light exit surface, luminance of outgoing light is lowered and the outgoing light easily becomes uneven.

Therefore, the applicant of the present invention has proposed a light guide plate which has a large and thin shape, and which can emit light having high light use efficiency and small luminance unevenness (see JP 4713697 B (Patent Document 2)). The light guide plate includes two layers (a first layer and a second layer) having different particle concentrations, in which a combined particle concentration in a direction perpendicular to a light incidence surface is varied in the direction substantially perpendicular to the light incidence surface by changing thicknesses of the first layer and the second layer in a direction perpendicular to a light exit surface.

### SUMMARY OF THE INVENTION

According to the light guide plate disclosed in Patent Document 2, even when the light guide plate has a large size and a small thickness, it is possible to enhance light use efficiency and to emit light having small luminance unevenness. However, since the light guide plate has a small thickness and includes two layers, an influence of thickness unevenness (dimensional tolerance) of the light guide plate becomes relatively larger. When the thickness of the light guide plate is uneven, a luminance distribution departs from a desired distribution and unevenness appears in outgoing light. Accordingly, in order to obtain a light guide plate capable of implementing a desired luminance distribution, it is necessary to reduce the dimensional tolerance, thereby causing difficulty in manufacturing and causing an increase in cost.

An object of the present invention is to solve the above-mentioned problems of the prior art and to provide a light guide plate which has a large and thin shape, can emit light having high light use efficiency and small luminance unevenness, can obtain a brightness distribution required for a large and thin liquid crystal television and so-called a middle-high or bell-shaped brightness distribution in which a portion around the center of a screen is brighter than the peripheral portion, and which can be easily manufactured.

In order to attain the above-described object, the present invention provides a light guide plate comprising: a rectangular light exit surface; a light incidence surface that is disposed on an end face of the light exit surface and on which light traveling in a direction substantially parallel to the light exit surface is incident; a rear surface that is opposite to the light exit surface; scattering particles that are dispersed therein; and two layers that overlap each other in a direction perpendicular to the light exit surface, wherein the two layers are a first layer disposed on a light exit surface side and a second layer disposed on a rear surface side and having a higher particle concentration of the scattering particles than that of the first layer, wherein thicknesses of the two layers in the direction substantially perpendicular to the light exit surface vary in a direction perpendicular to the light incidence surface to change a combined particle concentration, and wherein when a thickness of the light guide plate in the direction perpendicular to the light exit surface is defined as T_{lg} and the thickness at a center of the second layer is defined as t_{cen}, conditional expressions of 0.3 mm≦T_{lg}≦4 mm and 0.3≦t_{cen}/T_{lg}≦1 are satisfied.

Preferably, in the direction perpendicular to the light incidence surface, the light guide plate has a region in which the thickness of the second layer gradually decreases from the center thereof toward the light incidence surface, and when a smallest thickness of the second layer in the region is defined as tₘᵢₙ, a relationship of 2≦t_{cen}/tₘᵢₙ≦10 is satisfied.

Preferably, in the direction perpendicular to the light incidence surface, the light guide plate has a region in which the thickness of the second layer decreases up to a smallest thickness tₘᵢₙ and increases as it goes far away from the light incidence surface.

It is preferable that the light guide plate further comprises an additional light incidence surface that is opposite to the light incidence surface, and in the direction perpendicular to two light incidence surfaces including the light incidence surface and the additional light incidence surface, the thickness of the second layer is a largest thickness at the center thereof, and the thickness of the second layer smoothly varies so as to decrease up to the smallest thickness tₘᵢₙ and to increase as it goes close to each of the two light incidence surfaces from the center.

Or, it is preferable that the light guide plate further comprises an additional light incidence surface that is opposite to the light incidence surface, and in the direction perpendicular to two light incidence surfaces including the light incidence surface and the additional light incidence surface, the thickness of the second layer is a largest thickness at the center thereof, and the thickness of the second layer smoothly varies so as to decrease up to the smallest thickness tₘᵢₙ and to increase as it goes close to each of the two light incidence surfaces from the center, and then decreases.

Preferably, an interface between the first layer and the second layer has a region including two curved surfaces, which are concave to the light exit surface, on each side of the two light incidence surfaces and a curved surface which is smoothly connected to the two concave curved surfaces between the two concave curved surfaces and which is convex to the light exit surface.

Preferably, when a radius of curvature of the convex curved surface is defined as R1, a radius of curvature of the concave curved surfaces is defined as R2, and a distance between the two light incidence surfaces is defined as L_{lg}, T_{lg}·R1 and T_{lg}·R2 are located in a range surrounded with five points P_{R1}(6000·(L_{lg}/539)², 34000·(L_{lg}/539)²), P_{R2}(21000·(L_{lg}/539)², 16000·(L_{lg}/539)²), P_{R3}(82000·(L_{lg}/539)², 62000·(L_{lg}/539)²), P_{R4}(29500·(L_{lg}/539)², 67000·(L_{lg}/539)²), and P_{R5}(10000·(L_{lg}/539)², 54000·(L_{lg}/539)²) in a graph with T_{lg}·R1 taken as a horizontal axis and T_{lg}·R2 taken as a vertical axis.

Preferably, when the particle concentration of the first layer is defined as Npo and the particle concentration of the second layer is defined as Npr, conditional expressions of 0.0004 wt %≦Npo≦0.044 wt % and 0.008 wt %≦Npr≦0.3 wt % are satisfied.

Preferably, when the particle concentration of the first layer is defined as Npo, the particle concentration of the second layer is defined as Npr, and a distance between the two light incidence surfaces is defined as L_{lg}, Npo and Npr are located in a range surrounded with seven points P_{NP1}(0.001·(539/L_{lg}), 0.02·(539/L_{lg})), P_{NP2}(0.015·(539/L_{lg}), 0.02·(539/L_{lg})), P_{NP3}·(0.022·(539/L_{lg}), 0.035·(539/L_{lg})), P_{NP4}(0.022·(539/L_{lg}), 0.1·(539/L_{lg})), P_{NP5}(0.02·(539/L_{lg}), 0.15·(539/L_{lg})), and P_{NP6}(0.005·(539/L_{lg}), 0.15·(539/L_{lg})), P_{NP7}(0.001·(539/L_{lg}), 0.1·(539/L_{lg})) in a graph with Npo taken as a horizontal axis and Npr taken as a vertical axis.

Preferably, in the direction perpendicular to the light incidence surface, the thickness of the second layer smoothly varies so as to decrease up to the smallest thickness tₘᵢₙ, to increase up to a largest thickness, and to decrease again as it goes far away from the light incidence surface.

Preferably, in the direction perpendicular to the light incidence surface, the thickness of the second layer smoothly varies so as to decrease up to the smallest thickness tₘᵢₙ, to increase up to a largest thickness, and to maintain the largest thickness as it goes far away from the light incidence surface.

Preferably, in the direction perpendicular to the light incidence surface, the thickness of the second layer continuously varies so as to once increase, to decrease up to the smallest thickness tₘᵢₙ, to increase up to a largest thickness and to decrease again as it goes far away from the light incidence surface.

Preferably, in the direction perpendicular to the light incidence surface, the thickness of the second layer continuously varies so as to once increase, to decrease up to the smallest thickness tₘᵢₙ, to increase again up to a largest thickness, and to maintain the largest thickness as it goes far away from the light incidence surface.

Preferably, in the direction perpendicular to the light incidence surface, an interface between the first layer and the second layer in a region from a position at which the second layer has the smallest thickness tₘᵢₙ to a position at which the second layer has the largest thickness includes a curved surface which is concave to the light exit surface and a curved surface which is smoothly connected to the concave curved surface and which is convex to the light exit surface.

Preferably, when a radius of curvature of the convex curved surface is defined as R1, a radius of curvature of the concave curved surface is defined as R2, and a distance between the light incidence surface and a surface opposite to the light incidence surface is defined as L_{lg}, T_{lg}·R1 and T_{lg}·R2 are located in a range surrounded with four points P_{R1}(20000·(L_{lg}/539)², 180000·(L_{lg}/539)²), P_{R2}(54000·(L_{lg}/539)², 76000·(L_{lg}/539)²), P_{R3}(135000·(L_{lg}/539)², 135000·(L_{lg}/539)²), and P_{R4}(45000·(L_{lg}/539)², 300000·(L_{lg}/539)²) in a graph with T_{lg}·R1 taken as a horizontal axis and T_{lg}·R2 taken as a vertical axis.

Preferably, when the particle concentration of the first layer is defined as Npo and the particle concentration of the second layer is defined as Npr, conditional expressions of 0.0000573 wt %≦Npo≦0.021 wt % and 0.0064 wt %≦Npr≦0.19 wt % are satisfied.

Preferably, when a distance between the light incidence surface and a surface opposite to the light incidence surface is defined as L_{lg}, the particle concentration of the first layer is defined as Npo, and the particle concentration of the second layer is defined as Npr, Npo and Npr are located in a range surrounded with eight points P_{NP1}(0.00016·(539/L_{lg}), 0.054·(539/L_{lg})), P_{NP2}(0.0012·(539/L_{lg}), 0.018·(539/L_{lg})), P_{NP3}(0.009·(539/L_{lg}), 0.018·(539/L_{lg})), P_{NP4}(0.0095·(539/L_{lg}), 0.033·(539/L_{lg})), P_{NP5}(0.0095·(539/L_{lg}), 0.048·(539/L_{lg})), P_{NP6}(0.007·(539/L_{lg}), 0.088·(539/L_{lg})), P_{NP7}(0.0007·(539/L_{lg}), 0.088·(539/L_{lg})), and P_{NP8}(0.00016·(539/L_{lg}), 0.058·(539/L_{lg})) in a graph with Npo taken as a horizontal axis and Npr taken as a vertical axis.

Preferably, the light exit surface is a curved surface which is convex to the rear surface.

According to the present invention, the light guide plate includes two layers overlapping each other in the direction perpendicular to the light exit surface and having different particle concentrations, the thicknesses of the two layers in the direction substantially perpendicular to the light exit surface are varied in the direction perpendicular to the light incidence surface to change the combined particle concentration of the light guide plate, and conditional expressions of 0.3 mm≦T_{lg}≦4 mm and 0.3≦t_{cen}/T_{lg}≦1 are satisfied when the thickness in the direction perpendicular to the light exit surface is defined as T_{lg} and the thickness at the center of the second layer is defined as T_{cen}. Accordingly, the light guide plate can have a thin shape and can emit light having high light use efficiency and small luminance unevenness. In addition, according to the light guide plate of the invention, it is possible to obtain a brightness distribution required for a large and thin liquid crystal television and so-called a middle-high or bell-shaped brightness distribution in which a portion around the center of a screen is brighter than the peripheral portion, and further, it is possible to stably obtain a distribution close to a desired luminance distribution even when the dimensional tolerance is large, and thus the light guide plate of the invention can be easily manufactured.

### BRIEF DESCRIPTION OF THE DRAWINGS

FIG. 1 is a perspective view schematically illustrating an example of a liquid crystal display including a planar lighting device using a light guide plate according to the present invention.

FIG. 2 is a cross-sectional view taken along line II-II of the liquid crystal display illustrated in FIG. 1.

FIG. 3A is an arrow view taken along line III-III of the planar lighting device illustrated in FIG. 2, FIG. 3B is a cross-sectional view taken along line B-B of FIG. 3A, and FIG. 3C is a schematic cross-sectional view of the light guide plate.

FIG. 4A is a perspective view schematically illustrating a configuration of a light source unit of the planar lighting device illustrated in FIGS. 1 and 2 and FIG. 4B is an enlarged perspective view schematically illustrating one LED of the light source unit illustrated in FIG. 4A.

FIG. 5 is a perspective view schematically illustrating a shape of the light guide plate illustrated in FIG. 3.

FIG. 6 is a graph illustrating the thickness of a second layer of the light guide plate and a thickness error added to the light guide plate.

FIGS. 7A to 7D are graphs illustrating measurement results of an illuminance distribution of light exiting from a light exit surface of the light guide plate.

FIG. 8 is a graph illustrating a measurement result of an illuminance distribution of light exiting from the light exit surface of the light guide plate.

FIGS. 9A to 9C are graphs illustrating the thickness of a second layer of the light guide plate and a thickness error added to the light guide plate.

FIGS. 10A to 10D are graphs illustrating measurement results of an illuminance distribution of light exiting from the light exit surface of the light guide plate.

FIGS. 11A to 11D are graphs illustrating measurement results of an illuminance distribution of light exiting from the light exit surface of the light guide plate.

FIGS. 12A to 12D are graphs illustrating measurement results of an illuminance distribution of light exiting from the light exit surface of the light guide plate.

FIG. 13 is a graph illustrating a relationship between t_{cen}/T_{lg} and an average of departure.

FIGS. 14A to FIG. 14F are schematic cross-sectional views illustrating other examples of the light guide plate according to the present invention.

FIG. 15A is a diagram illustrating the thickness of the second layer and FIG. 15B is a graph illustrating a measurement result of an illuminance distribution of light exiting from the light exit surface of the light guide plate.

FIGS. 16A to 16D are graphs illustrating measurement results of an illuminance distribution of light exiting from the light exit surface of the light guide plate.

FIGS. 17A and 17B are schematic cross-sectional views illustrating other examples of the light guide plate according to the present invention.

FIGS. 18A and 18B are schematic cross-sectional views illustrating other examples of the light guide plate according to the present invention.

FIG. 19 is a graph illustrating a relationship between a combined particle concentration [wt %] and a position [mm] of the light guide plate.

FIG. 20 is a graph illustrating the thickness of the second layer of the light guide plate and a thickness error added to the light guide plate.

FIGS. 21A to 21F are graphs illustrating illuminance distributions of light exiting from the light exit surface of the light guide plate.

FIG. 22 is a graph illustrating a relationship between the number of scattering particles and efficiency.

FIG. 23 is a graph illustrating a relationship between a particle concentration and an illuminance departure due to the thickness error.

FIG. 24 is a graph illustrating ranges of a radius of curvature of a curved surface of an interface between the first layer and the second layer.

FIG. 25 is a graph illustrating particle concentration ranges of the first layer and the second layer.

FIG. 26A is a graph illustrating particle concentration ranges of the first layer and the second layer and FIG. 26B is a graph illustrating a range of a radius of curvature of a curved surface of an interface between the first layer and the second layer.

FIGS. 27A to 27C are graphs illustrating measurement results of an illuminance distribution of light exiting from the light exit surface of the light guide plate.

FIG. 28 is a graph illustrating particle concentration ranges of the first layer and the second layer.

FIG. 29 is a graph illustrating ranges of a radius of curvature of a curved surface of an interface between the first layer and the second layer.

### DETAILED DESCRIPTION OF THE INVENTION

A planar lighting device using a light guide plate according to the invention will be described below in detail with reference to preferred embodiments shown in the accompanying drawings.

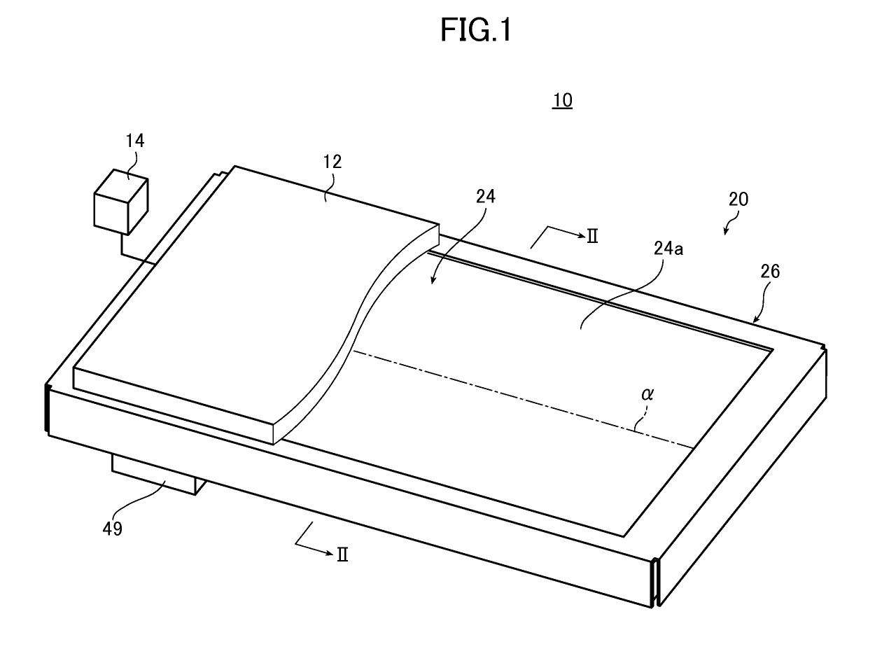

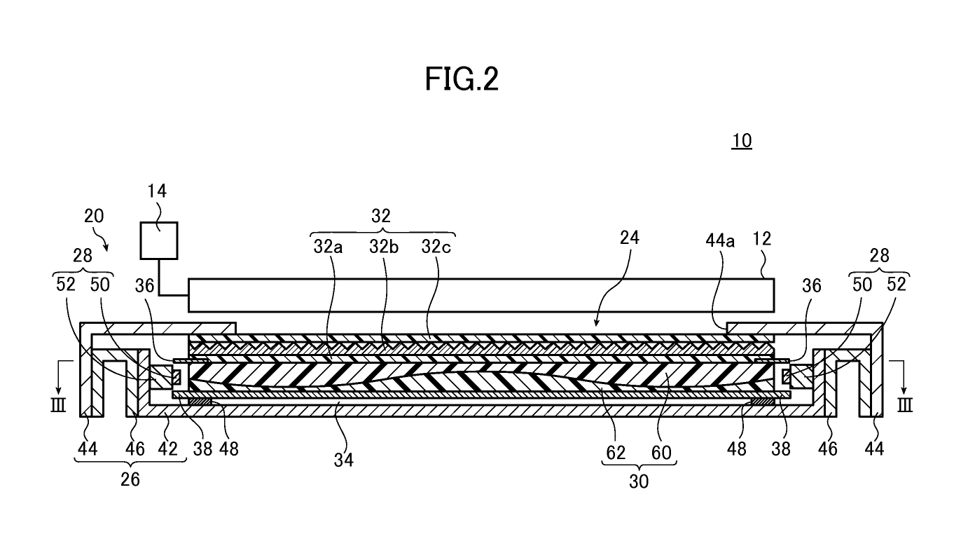

FIG. 1 is a perspective view schematically showing a liquid crystal display provided with the planar lighting device using the light guide plate according to the invention and FIG. 2 is a cross-sectional view of the liquid crystal display of FIG. 1 taken along line II-II.

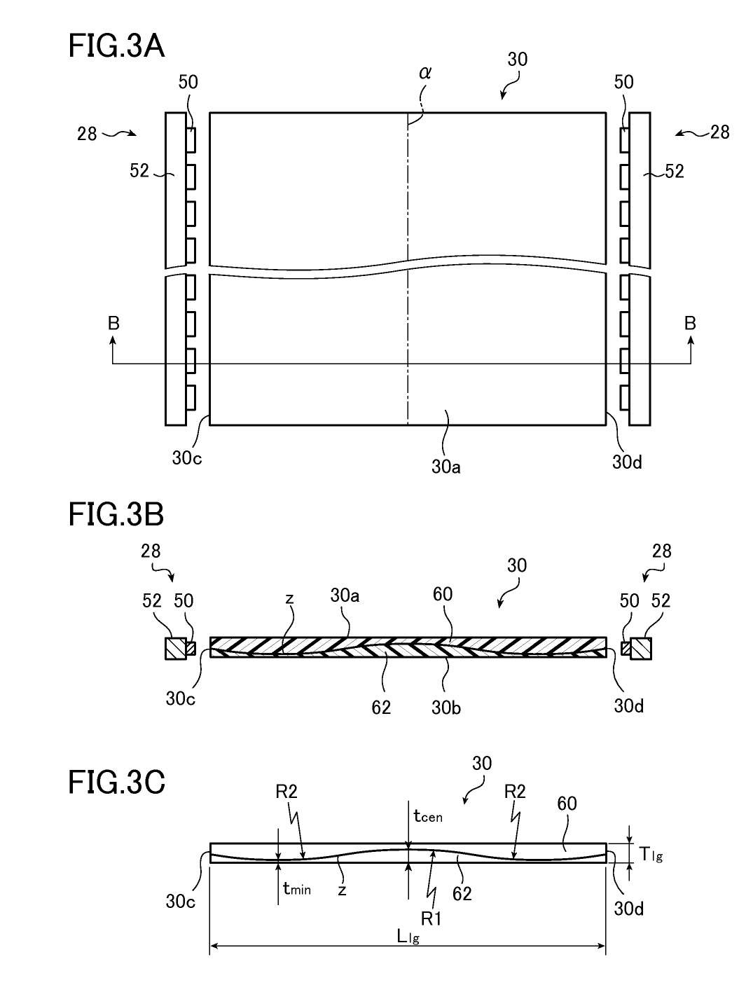

FIG. 3A is a view of the planar lighting device (also referred to below as “backlight unit”) shown in FIG. 2 taken along line III-III and FIG. 3B is a cross-sectional view of FIG. 3A taken along line B-B.

A liquid crystal display 10 comprises a backlight unit 20, a liquid crystal display panel 12 disposed on the side closer to a light exit surface of the backlight unit 20, and a drive unit 14 for driving the liquid crystal display panel 12. In FIG. 1, parts of the liquid crystal display panel 12 are not shown to illustrate the configuration of the backlight unit.

In the liquid crystal display panel 12, an electric field is partially applied to liquid crystal molecules previously arranged in a specified direction to thereby change the orientation of the molecules. As a result, changes in refractive index occur in the liquid crystal cells, and the changes in refractive index are used to display characters, figures, images and the like on the surface of the liquid crystal display panel 12.

The drive unit 14 applies a voltage to transparent electrodes in the liquid crystal display panel 12 to change the orientation of the liquid crystal molecules, thereby controlling the transmittance of light passing through the liquid crystal display panel 12.

The backlight unit 20 is a lighting device for illuminating the whole surface of the liquid crystal display panel 12 from the back side of the liquid crystal display panel 12 and comprises a light exit surface 24a of which the shape is substantially the same as an image display surface of the liquid crystal display panel 12.

As shown in FIGS. 1, 2, 3A, and 3B, the backlight unit 20 according to this embodiment comprises a lighting device main body 24 having two light source units 28, a light guide plate 30 and an optical member unit 32, and a housing 26 having a lower housing 42, an upper housing 44, folded members 46, and support members 48. As shown in FIG. 1, a power unit casing 49 containing a plurality of power supplies for supplying the light source units 28 with electric power is disposed on the back side of the lower housing 42 of the housing 26.

Components constituting the backlight unit 20 will be described below.

The lighting device main body 24 comprises the light source units 28 for emitting light, the light guide plate 30 for emitting the light from the light source units 28 as planar light, the optical member unit 32 for scattering or diffusing the light emitted from the light guide plate 30 to further reduce the unevenness of the light.

First, the light source units 28 will be described.

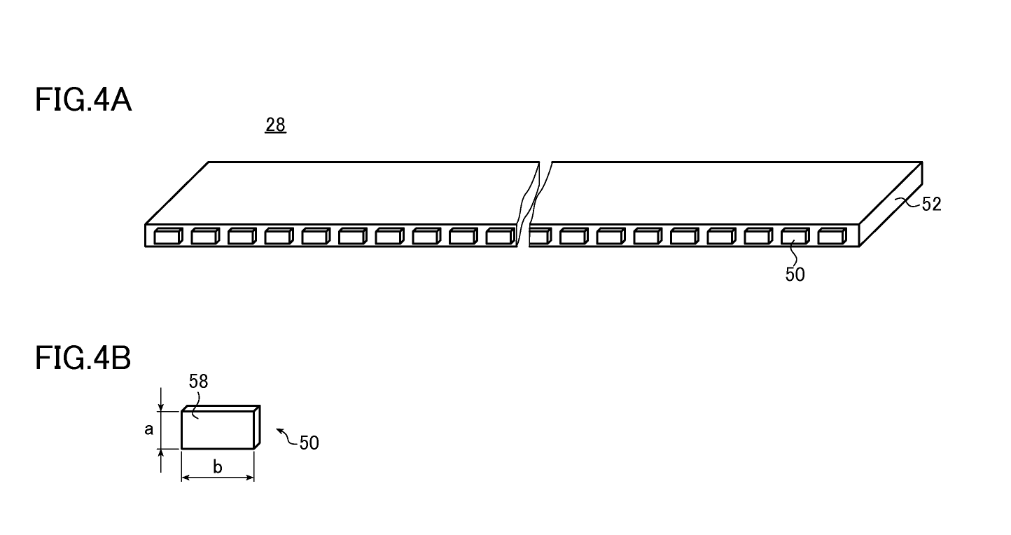

FIG. 4A is a schematic perspective view schematically showing the configuration of the light source unit 28 of the backlight unit 20 shown in FIGS. 1 and 2. FIG. 4B is an enlarged schematic perspective view showing only one LED chip of the light source unit 28 shown in FIG. 4A.

As shown in FIG. 4A, the light source unit 28 comprises a plurality of light emitting diode chips (referred to below as “LED chips”) 50 and a light source support 52.

The LED chip 50 is a chip of a light emitting diode emitting blue light, which has a phosphor applied to the surface thereof. The LED chip 50 has a light-emitting face 58 with a predetermined area and emits white light from the light-emitting face 58.

Specifically, when blue light emitted from the surface of the light emitting diode of the LED chip 50 passes through the phosphor, the phosphor emits fluorescence. Thus, the blue light emitted from the light emitting diode is combined with the light emitted as a result of the fluorescence of the phosphor to produce white light, which is emitted from the LED chip 50.

Examples of the LED chip 50 include chips obtained by applying a YAG (yttrium aluminum garnet) phosphor to the surface of a GaN light emitting diode, an InGaN light emitting diode, and the like.

The light source support 52 is a plate-like member of which one surface faces a light incidence surface (30c or 30d) of the light guide plate 30.

The light source support 52 supports the LED chips 50 on a side surface facing the light incidence surface (30c or 30d) of the light guide plate 30 with the LED chips spaced from each other at predetermined intervals. Specifically, the plural LED chips 50 constituting the light source unit 28 are arranged in an array shape in the length direction of the first light incidence surface 30c or the second light incidence surface 30d of the light guide plate 30 to be described later, and are fixed to the light source support 52.

The light source support 52 is formed of a metal having high heat conductivity such as copper or aluminum and also serves as a heat sink absorbing heat generated from the LED chips 50 and dissipating the generated heat to the outside. The light source support 52 may be provided with fins capable of increasing the surface area and the heat dissipation effect or heat pipes for transferring heat to a heat dissipating member.

As shown in FIG. 4B, each LED chip 50 according to this embodiment has a rectangular shape in which the length in a direction perpendicular to the arrangement direction of the LED chips 50 is smaller than the length in the arrangement direction, that is, a rectangular shape in which the thickness direction (direction perpendicular to a light exit surface 30a) of the light guide plate 30 to be described later is a short side. In other words, the LED chip 50 has a shape which satisfies b>a where the length in the direction perpendicular to the light exit surface 30a of the light guide plate 30 is defined as a and the length in the arrangement direction is defined as b. When the arrangement interval of the LED chips 50 is defined as q, q>b is satisfied. In this way, it is preferable that the relationship of the length a in the direction perpendicular to the light exit surface 30a of the light guide plate 30, the length b in the arrangement direction, and the arrangement interval q of the LED chips 50 satisfy q>b>a.

By forming each LED chip 50 having a rectangular shape, it is possible to provide a thin light source unit while maintaining an output with large light intensity. By decreasing the thickness of the light source unit 28, it is possible to decrease the thickness of a backlight unit. It is also possible to reduce the number of LED chips arranged.

While the LED chips 50 each preferably have a rectangular shape with the short side lying in the thickness direction of the light guide plate 30 for a thinner design of the light source unit 28, the invention is not limited thereto and LED chips having various shapes such as a square shape, a circular shape, a polygonal shape, and an elliptical shape may be used.

Next, the light guide plate 30 will be described below.

FIG. 5 is a schematic perspective view showing the shape of the light guide plate 30.

As shown in FIGS. 2, 3A, and 5, the light guide plate 30 includes the rectangular light exit surface 30a, the two light incidence surfaces (the first light incidence surface 30c and the second light incidence surface 30d) formed at both ends on the long side of the light exit surface 30a so as to be substantially perpendicular to the light exit surface 30a, and a flat rear surface 30b located on the opposite side to the light exit surface 30a, that is, on the back side of the light guide plate 30.

The two light source units 28 mentioned above are disposed so as to face the first light incidence surface 30c and the second light incidence surface 30d of the light guide plate 30, respectively. In this embodiment, the light-emitting face 58 of each LED chip 50 in the light source units 28 has substantially the same length as the first light incidence surface 30c and the second light incidence surface 30d in the direction substantially perpendicular to the light exit surface 30a.

Thus, the backlight unit 20 has the two light source units 28 disposed so as to interpose the light guide plate 30 therebetween. In other words, the light guide plate 30 is disposed between the two light source units 28 facing each other with a predetermined space therebetween.

The light guide plate 30 is formed by kneading and dispersing scattering particles for scattering light into a transparent resin. Exemplary materials of the transparent resin used for the light guide plate 30 include optically transparent resins such as PET (polyethylene terephthalate), PP (polypropylene), PC (polycarbonate), PMMA (polymethyl methacrylate), benzyl methacrylate, MS resin, and COP (cycloolefin polymer). Silicone particles such as TOSPEARL (registered trademark), silica particles, zirconia particles, dielectric polymer particles, and the like may be used as the scattering particles to be kneaded and dispersed into the light guide plate 30.

The light guide plate 30 has a two-layer structure including a first layer 60 on the side closer to the light exit surface 30a and a second layer 62 on the side closer to the rear surface 30b. When the boundary between the first layer 60 and the second layer 62 is referred to as “interface z,” the first layer 60 has a sectional region surrounded by the light exit surface 30a, the first light incidence surface 30c, the second light incidence surface 30d, and the interface z. On the other hand, the second layer 62 is a layer adjacent to the first layer 60 on the side closer to the rear surface 30b and has a sectional region surrounded by the interface z and the rear surface 30b.

When the particle concentration of the scattering particles in the first layer 60 and the particle concentration of the scattering particles in the second layer 62 are denoted by Npo and Npr, respectively, Npo and Npr have a relationship expressed by Npo<Npr. That is, in the light guide plate 30, the second layer on the side closer to the rear surface 30b contains the scattering particles at a higher particle concentration than the first layer on the side closer to the light exit surface 30a.

The interface z between the first layer 60 and the second layer 62 smoothly varies so that the thickness of the second layer 62 decreases from the position of the bisector α of the light exit surface 30a (that is, the center of the light exit surface) toward the first light incidence surface 30c and the second light incidence surface 30d and further smoothly varies so that the thickness of the second layer 62 increases in the vicinity of the first light incidence surface 30c and second light incidence surface 30d, respectively, when viewed in a cross-section perpendicular to the length direction of the light incidence surfaces.

Specifically, the interface Z includes a curved surface which is convex to the light exit surface 30a at the center of the light guide plate 30 and concave curved surfaces which are smoothly connected to the convex curved surface and respectively connected to the light incidence surfaces 30c and 30d.

By thus continuously changing the thickness of the second layer having a higher particle concentration of scattering particles than that of the first layer 60 so as to have a local maximum value showing the largest thickness at the center of the light guide plate and a local minimum value showing the smallest thickness in the vicinity of the light incidence surfaces, the combined particle concentration of the scattering particles is changed so as to have the local minimum value in the vicinity of the first and second light incidence surfaces (30c and 30d) and the local maximum value at the center of the light guide plate.

That is, the profile of the combined particle concentration has a curve which varies so as to have a local maximum value showing the largest concentration at the center of the light guide plate and have a local minimum value at positions away from the center by about two-thirds of the distance from the center to the light incidence surfaces on both sides in the illustrated example.

Here, the combined particle concentration in the invention means a concentration of scattering particles expressed using the amount of scattering particles added (combined) in a direction substantially perpendicular to the light exit surface at a position spaced apart from one light incidence surface toward the other on the assumption that the light guide plate is a flat plate having the thickness at the light incidence surfaces throughout the light guide plate. In other words, the combined particle concentration means the number of scattering particles per unit volume or a weight percentage with respect to the base material of scattering particles added in a direction substantially perpendicular to the light exit surface at a position spaced apart from the light incidence surface on the assumption that the light guide plate is a flat light guide plate which has the thickness of the light incidence surfaces throughout the light guide plate and which has the same concentration.

In this way, the thickness of the second layer having a higher particle concentration is configured such that the thickness smoothly varies so as to be the largest at the center of the light guide plate, to decrease as it goes from the center toward the light incidence surfaces, and to increase in the vicinity of the light incidence surfaces, thereby causing the combined particle concentration to smoothly vary so as to once decrease, to increase, and to be the highest at the center of the light guide plate as it goes from the light incidence surfaces toward the center of the light guide plate. Therefore, even a large and thin light guide plate can send light incident from the light incidence surfaces to a far position, thereby obtaining a middle-high luminance distribution of outgoing light.

By setting the combined particle concentration in the vicinity of the light incidence surfaces to be higher than the minimum value, it is possible to sufficiently diffuse light incident from the light incidence surfaces in the vicinity of the light incidence surfaces and thus to prevent a bright line (dark line, unevenness) due to the arrangement interval of the light sources or the like from being visualized in outgoing light exiting from the vicinity of the light incidence surfaces.

By adjusting the shape of the interface z, it is possible to arbitrarily set a luminance distribution (a concentration distribution of scattering particles) and thus to improve efficiency as much as possible.

Since the particle concentration of the layer on the light exit surface side is set to be lower, it is possible to reduce the amount of scattering particles as a whole and thus to reduce costs.

Though the light guide plate 30 is divided into the first layer 60 and the second layer 62 by the interface z, the first layer 60 and the second layer 62 have a configuration in which the same scattering particles are dispersed in the same transparent resin except that the particle concentrations thereof are different from each other and are structurally formed as a unified body. That is, when the light guide plate 30 is divided into regions by the interface z, the particle concentrations of the respective regions are different from each other, but the interface z is a virtual surface and the first layer 60 and the second layer 62 are formed as a unified body.

The light guide plate 30 can be manufactured using an extrusion molding method or an injection molding method.

Here, as described above, when the light guide plate has a small thickness and has two layers, the influence of thickness unevenness (dimensional tolerance) of the light guide plate becomes relatively large. Accordingly, when the thickness of the light guide plate is uneven, the luminance distribution (illuminance distribution) departs from a desired distribution and unevenness appears in outgoing light. Accordingly, in order to obtain a light guide plate capable of realizing a desired luminance distribution, it is necessary to reduce the dimensional tolerance, and thus there is a problem in that it is difficult to manufacture the light guide plate and the costs thereof increase.

Therefore, in the present invention, by defining the thicknesses of the layers, even a light guide plate having a large and thin shape can be less affected by the thickness unevenness and can stably emit light having high light use efficiency and small luminance unevenness, thereby obtaining a middle-high or bell-shaped brightness distribution.

FIG. 3C is a cross-sectional view conceptually illustrating the light guide plate 30.

As illustrated in FIG. 3C, when it is assumed that the thickness of the light guide plate 30 is defined as T_{lg}, the thickness (largest thickness) at the center (the position of the local maximum value) of the second layer 62 is defined as t_{cen}, and the thickness (the smallest thickness) of the second layer 62 at the position of the local minimum value is defined as tₘᵢₙ, and when the thickness of the light guide plate 30 is decreased so that the thickness T_{lg} of the light guide plate 30 is in a range of 0.3 mm≦T_{lg}≦4 mm, the thickness t_{cen} at the center of the second layer 62 and the thickness T_{lg} of the light guide plate 30 satisfy a conditional expression of 0.3≦t_{cen}/T_{lg}≦1.

Since the thickness t_{cen} at the center of the second layer 62 and the thickness T_{lg} of the light guide plate 30 satisfy the conditional expression of 0.3≦t_{cen}/T_{lg}≦1, it is possible to improve robustness. Accordingly, even a light guide plate having a large and thin shape can be less affected by the thickness unevenness and can stably emit light having high light use efficiency and small luminance unevenness, thereby obtaining a middle-high or bell-shaped brightness distribution.

It is preferable that the smallest thickness Tₘᵢₙ of the second layer and the thickness t_{cen} at the center thereof satisfy 2≦t_{cen}/tₘᵢₙ≦10. By causing the smallest thickness Tₘᵢₙ of the second layer and the thickness t_{cen} at the center thereof to satisfy the above-mentioned range, it is possible to further reduce the influence of the thickness unevenness and to stably emit light having high light use efficiency and small luminance unevenness, thereby obtaining a middle-high or bell-shaped brightness distribution.

Hereinafter, these points will be described in conjunction with specific examples.

### Example 1

In Example 1, normalized illuminance distributions of outgoing light were calculated by computer simulation while variously changing the specification of the light guide plate 30 illustrated in FIGS. 3A and 3B.

In the simulation, a model was prepared using PMMA as the transparent resin material of the light guide plate and using silicone as the material of scattering particles. This is true of all the following examples.

In Example 1-1, a light guide plate 30 corresponding to a screen size of 40 inches was used. Specifically, the light guide plate 30 in which the length L_{lg} from the first light incidence surface 30c to the second light incidence surface 30d (the length of the light guide plate) was set to 539 mm, the thickness T_{lg} in the direction perpendicular to the light exit surface 30a (the thickness of the light guide plate) was set to 2 mm, and the particle diameter of scattering particles to be kneaded and dispersed therein was set to 4.5 μm was used.

In such a light guide plate 30, the combined particle concentration which has a middle-high illuminance distribution and in which the lowest illuminance in the vicinity of the light incidence surfaces was 75 when the highest illuminance at the center of outgoing light was assumed to be 100 was calculated for three types (A, B, and C) while changing the light use efficiency. When the efficiency of the combined particle concentration A having the highest light use efficiency of three types was defined as 100, the efficiency of the combined particle concentration B was 98 and the efficiency of the combined particle concentration C was 92.

For each of the three types of combined particle concentrations, illuminance distributions were calculated when a thickness error (unevenness) was added to the second layer while variously changing a ratio t_{cen}/T_{lg} between the thickness T_{lg} of the light guide plate 30 and the thickness t_{cen} at the center of the second layer 62 and a ratio t_{cen}/tₘᵢₙ between the smallest thickness tₘᵢₙ of the second layer 62 and the thickness t_{cen} at the center thereof. Specifically, the thickness t_{cen} at the center of the second layer was set to six types of 0.4 mm, 0.6 mm, 0.8 mm, 1.2 mm, 1.6 mm, and 1.95 mm and the ratio t_{cen}/tₘᵢₙ between the smallest thickness tₘᵢₙ and the thickness t_{cen} at the center was set to three types of 5, 3, and 2.

In the thickness error added to the thickness of the second layer, the period thereof was set to about ⅓ of the length (the distance between the light incidence surfaces) of the light guide plate and the amplitude thereof was set to ±50 μm.

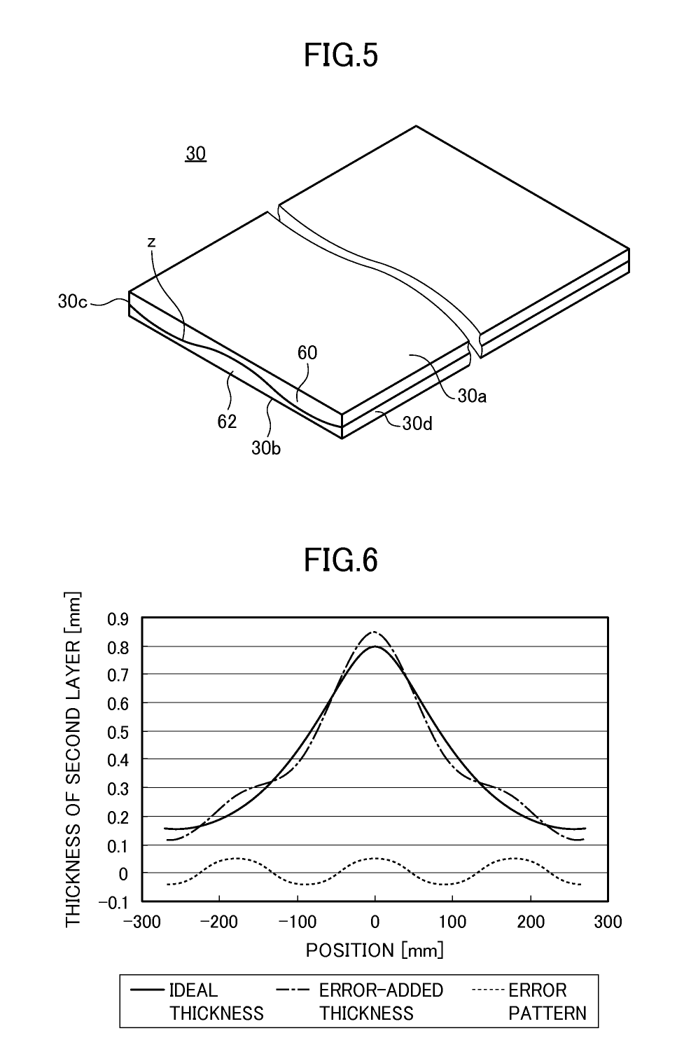

FIG. 6 is a graph illustrating the thickness of the second layer 62 of the light guide plate 30 and the thickness error added to the light guide plate 30.

In FIG. 6, an example of an ideal thickness (designed thickness) of the second layer is indicated by a solid line, an error pattern is indicated by a dotted line, and the thickness of the second layer having an error added thereto is indicated by a one-dot chained line. As illustrated in FIG. 6, in a thin light guide plate, it could be seen that the thickness of the second layer greatly departed from the ideal thickness by adding the error pattern with an amplitude of ±50 μm.

In various combinations of the combined particle concentrations, the ratio t_{cen}/T_{lg} between the thickness T_{lg} of the light guide plate 30 and the thickness t_{cen} at the center of the second layer 62, and the ratio t_{cen}/tₘᵢₙ between the smallest thickness tₘᵢₙ of the second layer 62 and the thickness t_{cen} at the center thereof, an illuminance distribution when the error pattern was added (actual distribution) and an illuminance distribution when the error pattern was not added (ideal distribution) were calculated and compared with each other.

Specifically, an average [%] of departure of the actual distribution from the ideal distribution was calculated. The calculation results are shown in Table 1.

Further, a value (the maximum value of departure) [%] obtained by adding the maximum value of departure in a direction in which the actual distribution becomes higher than the ideal distribution and the maximum value of departure in a direction in which the actual distribution becomes lower than the ideal distribution was calculated. The results are shown in Table 2. At the time of calculating the maximum value of departure, the actual distribution and the ideal distribution were compared with each other except the vicinity of the light incidence surfaces.

The particle concentration [wt %] of the first layer 60 and the particle concentration [wt %] of the second layer 62 in each case are shown in Table 3 and Table 4, respectively.

TABLE 1

| | |
|---|---|
| Combined | |
| particle | t_{cen}/T_{lg} |

| t_{cen}/tₘᵢₙ | concentration | 0.2 | 0.3 | 0.4 | 0.6 | 0.8 | 0.975 |
|---|---|---|---|---|---|---|---|
| 5 | A | 13.6 | 9.0 | 7.3 | 4.6 | 3.5 | 3.5 |
| | B | 9.4 | 6.0 | 4.7 | 3.2 | 2.9 | 2.1 |
| | C | 6.8 | 4.5 | 3.3 | 2.5 | 1.4 | 1.3 |
| 3 | A | — | — | — | — | — | — |
| | B | 11.6 | 7.8 | 5.7 | 4.4 | 2.7 | 2.5 |
| | C | 7.7 | 5.3 | 4.6 | 2.7 | 2.0 | 1.7 |
| 2 | A | — | — | — | — | — | — |
| | B | — | — | — | — | — | — |
| | C | 10.4 | 6.5 | 4.9 | 3.8 | 2.9 | 2.9 |

TABLE 2

| | |
|---|---|
| Combined | |
| particle | t_{cen}/T_{lg} |

| t_{cen}/tₘᵢₙ | concentration | 0.2 | 0.3 | 0.4 | 0.6 | 0.8 | 0.975 |
|---|---|---|---|---|---|---|---|
| 5 | A | 53.4 | 37.4 | 27.8 | 19.1 | 15.4 | 12.7 |
| | B | 33.0 | 21.1 | 17.0 | 13.1 | 14.2 | 10.5 |
| | C | 21.0 | 14.3 | 12.8 | 9.8 | 7.2 | 7.2 |
| 3 | A | — | — | — | — | — | — |
| | B | 39.8 | 26.0 | 20.5 | 15.1 | 12.8 | 9.7 |
| | C | 24.7 | 16.6 | 14.9 | 9.5 | 9.4 | 8.8 |
| 2 | A | — | — | — | — | — | — |
| | B | — | — | — | — | — | — |
| | C | 31.1 | 21.5 | 17.2 | 13.3 | 10.2 | 9.2 |

TABLE 3

| | Combined particle | t_{cen}/T_{lg} | | | | | |
|---|---|---|---|---|---|---|---|
| t_{cen}/tₘᵢₙ | concentration | 0.2 | 0.3 | 0.4 | 0.6 | 0.8 | 0.975 |
| 5 | A | 0.0051 | 0.0051 | 0.0051 | 0.0051 | 0.0051 | 0.0051 |
| | B | 0.0099 | 0.0099 | 0.0099 | 0.0099 | 0.0099 | 0.0099 |
| | C | 0.0112 | 0.0112 | 0.0112 | 0.0112 | 0.0112 | 0.0112 |
| 3 | A | — | — | — | — | — | — |
| | B | 0.0032 | 0.0032 | 0.0032 | 0.0032 | 0.0032 | 0.0032 |
| | C | 0.0079 | 0.0079 | 0.0079 | 0.0079 | 0.0079 | 0.0079 |
| 2 | A | — | — | — | — | — | — |
| | B | — | — | — | — | — | — |
| | C | 0.0019 | 0.0019 | 0.0019 | 0.0019 | 0.0019 | 0.0019 |

TABLE 4

| | Combined particle | t_{cen}/T_{lg} | | | | | |
|---|---|---|---|---|---|---|---|
| t_{cen}/tₘᵢₙ | concentration | 0.2 | 0.3 | 0.4 | 0.6 | 0.8 | 0.975 |
| 5 | A | 0.45 | 0.29 | 0.21 | 0.14 | 0.10 | 0.08 |
| | B | 0.24 | 0.16 | 0.12 | 0.08 | 0.06 | 0.05 |
| | C | 0.11 | 0.07 | 0.06 | 0.04 | 0.03 | 0.03 |
| 3 | A | — | — | — | — | — | — |
| | B | 0.28 | 0.18 | 0.13 | 0.08 | 0.06 | 0.05 |
| | C | 0.13 | 0.08 | 0.06 | 0.04 | 0.03 | 0.03 |
| 2 | A | — | — | — | — | — | — |
| | B | — | — | — | — | — | — |
| | C | 0.16 | 0.10 | 0.08 | 0.05 | 0.04 | 0.03 |

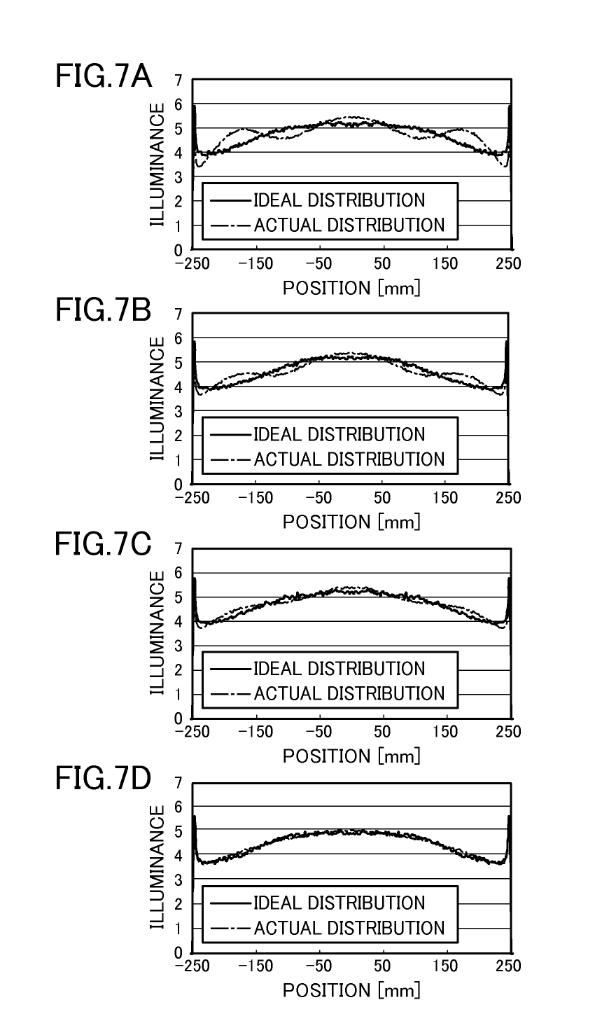

FIGS. 7A to 7D illustrate examples of the measurement results of the illuminance distribution of light exiting from a light exit surface of the light guide plate.

FIG. 7A illustrates an actual distribution (one-dot chained line) and an ideal distribution (solid line) of illuminance when t_{cen}/T_{lg} is set to 0.4, t_{cen}/tₘᵢₙ is set to 5, and the combined particle concentration is of type A (with efficiency of 100).

FIG. 7B illustrates an actual distribution (one-dot chained line) and an ideal distribution (solid line) of illuminance when t_{cen}/T_{lg} is set to 0.4, t_{cen}/tₘᵢₙ is set to 5, and the combined particle concentration is of type B (with efficiency of 98).

FIG. 7C illustrates an actual distribution (one-dot chained line) and an ideal distribution (solid line) of illuminance when t_{cen}/T_{lg} is set to 0.975, t_{cen}/tₘᵢₙ is set to 5, and the combined particle concentration is of type A (with efficiency of 100).

FIG. 7D illustrates an actual distribution (one-dot chained line) and an ideal distribution (solid line) of illuminance when t_{cen}/T_{lg} is set to 0.6, t_{cen}/tₘᵢₙ is set to 5, and the combined particle concentration is of type C (with efficiency of 92).

An illuminance distribution of a commercially-available TV (SONY EX700) was measured as a comparative example.

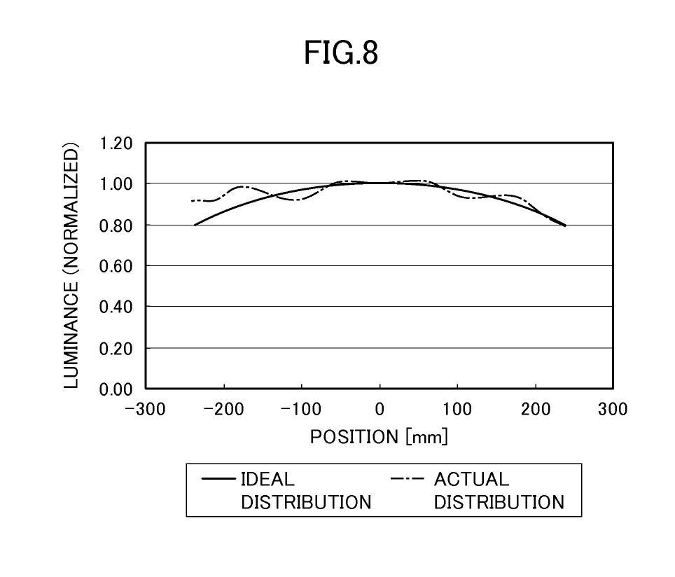

The measurement result of illuminance is illustrated in FIG. 8.

The measured illuminance distribution is indicated by the one-dot chained line. As indicated by the solid line, a smooth quadratic curve having the same degree of middle-high distribution as the measurement result was set as the ideal distribution.

In the comparative example, the average of departure of the actual distribution from the ideal distribution was 5%. The maximum value of departure was 18%.

It can be seen from Tables 1 and 2 and FIGS. 7A to 7D that the higher the efficiency becomes, the larger the average of departure and the maximum value of departure become and the larger the illuminance unevenness becomes. It can also be seen that the larger t_{cen}/T_{lg} becomes, the smaller the average of departure and the maximum value of departure become and the smaller the illuminance unevenness becomes.

It can also be seen that the larger t_{cen}/tₘᵢₙ becomes, the smaller the average of departure and the maximum value of departure become and the smaller the illuminance unevenness becomes.

For example, when t_{cen}/T_{lg} is set to 0.4, t_{cen}/tₘᵢₙ is set to 5, and the combined particle concentration is of type A (with efficiency of 100), as shown in Tables 1 and 2, the average of departure and the maximum value of departure are 7.3% and 27.8%, respectively, which are larger than those in the comparative example. In addition, as illustrated in FIG. 7A, the departure of the actual distribution of illuminance from the ideal distribution is large, the distribution is uneven, and the unevenness is large.

On the other hand, when t_{cen}/T_{lg} is set to 0.4, t_{cen}/tₘᵢₙ is set to 5, and the combined particle concentration is of type B (with efficiency of 98), the average of departure and the maximum value of departure are 4.7% and 17.0%, respectively, which are equal to those in the comparative example. As illustrated in FIG. 7B, the departure of the actual distribution of illuminance from the ideal distribution is equal to or less than that of the comparative example, and the unevenness close to that of the comparative example appears in the illuminance distribution.

When t_{cen}/T_{lg} is set to 0.975, t_{cen}/tₘᵢₙ is set to 5, and the combined particle concentration is of type A (with efficiency of 100), the average of departure and the maximum value of departure are 3.5% and 12.7%, respectively, which are smaller than those in the comparative example. As illustrated in FIG. 7C, the departure of the actual distribution of illuminance from the ideal distribution is smaller than that of the comparative example, and the unevenness of the distribution is small.

When t_{cen}/T_{lg} is set to 0.6, t_{cen}/tₘᵢₙ is set to 5, and the combined particle concentration is of type C (with efficiency of 92), the average of departure and the maximum value of departure are 2.5% and 7.2%, respectively, which are smaller than those in the comparative example. As illustrated in FIG. 7D, the departure of the actual distribution of illuminance from the ideal distribution is smaller than that of the comparative example, and the unevenness of the distribution is small.

Next, another error pattern was added and the illuminance distribution was calculated in the same way as described above.

FIGS. 9A to 9C are graphs illustrating the thickness of the second layer of each light guide plate and a pattern of the thickness error added to the light guide plate, where the error pattern is indicated by a dotted line, an example of the ideal thickness of the second layer is indicated by a solid line, and the thickness of the second layer having an error added thereto is indicated by a one-dot chained line. In each of the error patterns illustrated in FIGS. 9A to 9C, the period was changed with an amplitude of ±50 μm. The error pattern illustrated in FIG. 9A had a period set to about half of the length L_{lg} of the light guide plate and had a shape which was concave at the center of the light guide plate. The error pattern illustrated in FIG. 9B had a period set to about one-third of the length L_{lg} of the light guide plate and had a shape which was concave at the center of the light guide plate. The error pattern illustrated in FIG. 9C has a period set to about half of the length L_{lg} of the light guide plate and had a shape which was convex at the center of the light guide plate.

In Example 1-2, the illuminance distribution was calculated and the average of departure [%] from the ideal distribution, and the maximum value of departure [%] were calculated in the same way as in Example 1-1, except that the error pattern illustrated in FIG. 9A was added. The results are shown in Tables 5 and 6.

TABLE 5

| | Combined particle | t_{cen}/T_{lg} | | | | | |
|---|---|---|---|---|---|---|---|
| t_{cen}/tₘᵢₙ | concentration | 0.2 | 0.3 | 0.4 | 0.6 | 0.8 | 0.975 |
| 5 | A | 14.7 | 9.8 | 7.3 | 5.6 | 4.0 | 3.2 |
| | B | 10.4 | 8.0 | 6.2 | 4.2 | 2.7 | 3.1 |
| | C | 7.0 | 4.8 | 4.5 | 2.5 | 3.4 | 2.2 |
| 3 | A | — | — | — | — | — | — |
| | B | 12.4 | 8.2 | 6.7 | 4.6 | 4.1 | 3.5 |
| | C | 8.7 | 6.1 | 4.4 | 2.8 | 2.7 | 2.5 |
| 2 | A | — | — | — | — | — | — |
| | B | — | — | — | — | — | — |
| | C | 11.6 | 8.3 | 6.7 | 3.6 | 2.6 | 2.6 |

TABLE 6

| | Combined particle | t_{cen}/T_{lg} | | | | | |
|---|---|---|---|---|---|---|---|
| t_{cen}/tₘᵢₙ | concentration | 0.2 | 0.3 | 0.4 | 0.6 | 0.8 | 0.975 |
| 5 | A | 61.7 | 43.2 | 29.3 | 20.2 | 17.5 | 16.5 |
| | B | 38.5 | 26.0 | 21.3 | 14.4 | 13.1 | 10.5 |
| | C | 22.2 | 15.9 | 12.4 | 10.5 | 9.2 | 8.9 |
| 3 | A | — | — | — | — | — | — |
| | B | 44.7 | 32.3 | 21.8 | 15.5 | 12.3 | 11.2 |
| | C | 24.4 | 19.6 | 15.4 | 10.4 | 9.3 | 8.8 |
| 2 | A | — | — | — | — | — | — |
| | B | — | — | — | — | — | — |
| | C | 34.3 | 22.9 | 19.0 | 13.1 | 12.7 | 9.1 |

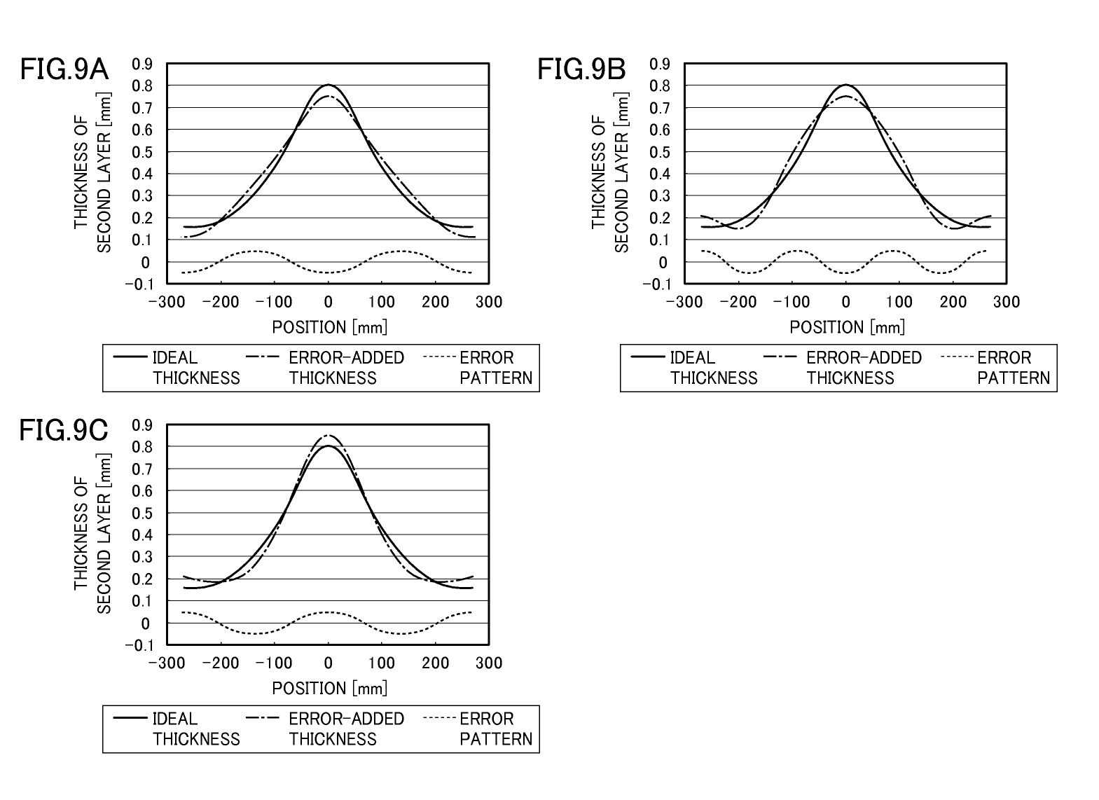

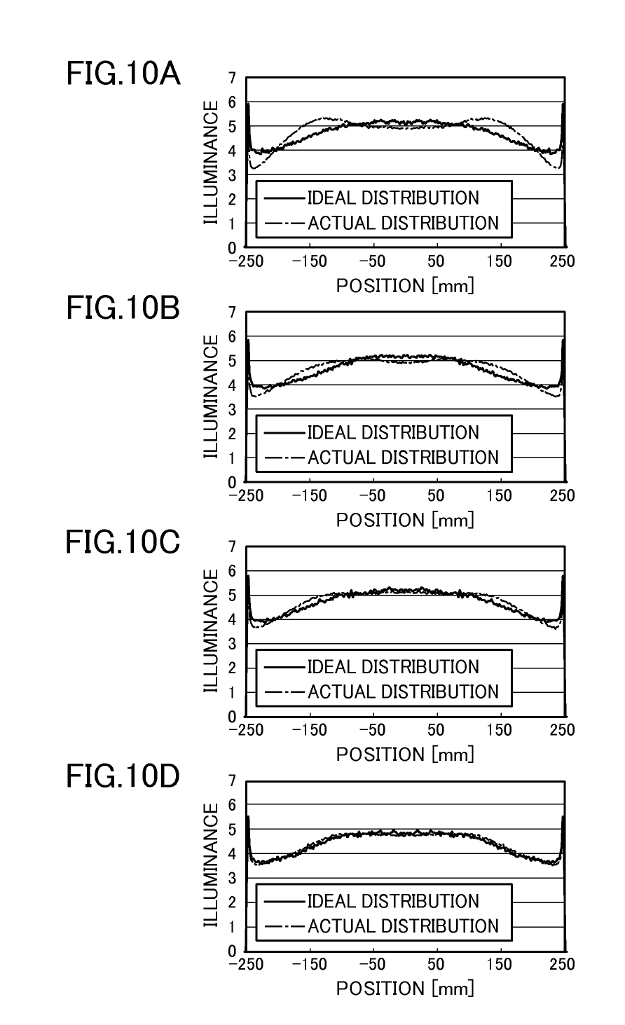

FIGS. 10A to 10D illustrate examples of the measurement result of the illuminance distribution of light exiting from a light exit surface of the light guide plate.

FIG. 10A illustrates an actual distribution (one-dot chained line) and an ideal distribution (solid line) of illuminance when t_{cen}/T_{lg} is set to 0.4, t_{cen}/tₘᵢₙ is set to 5, and the combined particle concentration is of type A (with efficiency of 100).

FIG. 10B illustrates an actual distribution (one-dot chained line) and an ideal distribution (solid line) of illuminance when t_{cen}/T_{lg} is set to 0.4, t_{cen}/tₘᵢₙ is set to 5, and the combined particle concentration is of type B (with efficiency of 98).

FIG. 10C illustrates an actual distribution (one-dot chained line) and an ideal distribution (solid line) of illuminance when t_{cen}/T_{lg} is set to 0.975, t_{cen}/tₘᵢₙ is set to 5, and the combined particle concentration is of type A (with efficiency of 100).

FIG. 10D illustrates an actual distribution (one-dot chained line) and an ideal distribution (solid line) of illuminance when t_{cen}/T_{lg} is set to 0.6, t_{cen}/tₘᵢₙ is set to 5, and the combined particle concentration is of type C (with efficiency of 92).

In Example 1-3, the illuminance distribution was calculated and the average of departure [%] from the ideal distribution, and the maximum value of departure [%] were calculated in the same way as in Example 1-1, except that the error pattern illustrated in FIG. 9B was added. The results are shown in Tables 7 and 8.

TABLE 7

| | Combined particle | t_{cen}/T_{lg} | | | | | |
|---|---|---|---|---|---|---|---|
| t_{cen}/tₘᵢₙ | concentration | 0.2 | 0.3 | 0.4 | 0.6 | 0.8 | 0.975 |
| 5 | A | 14.5 | 9.2 | 6.9 | 4.7 | 3.7 | 2.7 |
| | B | 9.5 | 6.4 | 4.9 | 3.2 | 2.3 | 2.0 |
| | C | 5.9 | 4.0 | 3.2 | 2.0 | 1.8 | 1.6 |
| 3 | A | — | — | — | — | — | — |
| | B | 11.2 | 7.4 | 5.6 | 3.7 | 3.0 | 2.4 |
| | C | 7.4 | 4.9 | 3.6 | 2.5 | 2.1 | 1.8 |
| 2 | A | — | — | — | — | — | — |
| | B | — | — | — | — | — | — |
| | C | 9.5 | 6.5 | 4.9 | 3.2 | 2.4 | 1.9 |

TABLE 8

| | Combined particle | t_{cen}/T_{lg} | | | | | |
|---|---|---|---|---|---|---|---|
| t_{cen}/tₘᵢₙ | concentration | 0.2 | 0.3 | 0.4 | 0.6 | 0.8 | 0.975 |
| 5 | A | 51.6 | 35.4 | 26.4 | 18.5 | 14.2 | 11.4 |
| | B | 31.6 | 21.4 | 15.9 | 11.4 | 8.7 | 8.7 |
| | C | 18.3 | 13.3 | 9.4 | 7.5 | 6.1 | 5.0 |
| 3 | A | — | — | — | — | — | — |
| | B | 37.3 | 25.2 | 19.7 | 13.6 | 10.7 | 8.2 |
| | C | 22.8 | 15.4 | 12.3 | 8.9 | 6.9 | 6.1 |
| 2 | A | — | — | — | — | — | — |
| | B | — | — | — | — | — | — |
| | C | 28.9 | 20.3 | 15.1 | 10.0 | 8.3 | 7.4 |

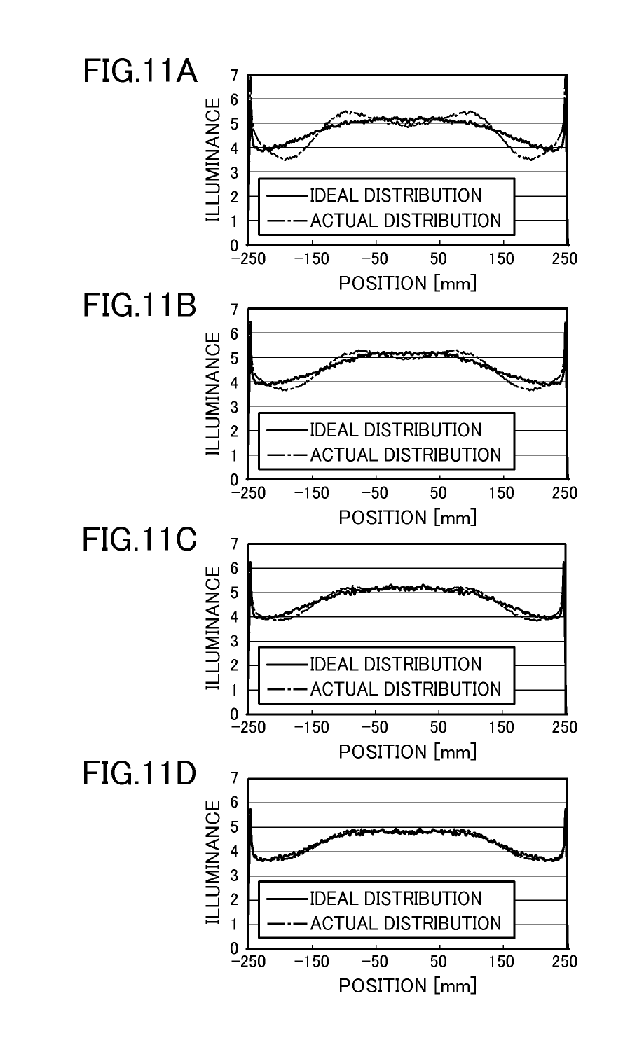

FIGS. 11A to 11D illustrate examples of the measurement result of the illuminance distribution of light exiting from a light exit surface of the light guide plate.

FIG. 11A illustrates an actual distribution (one-dot chained line) and an ideal distribution (solid line) of illuminance when t_{cen}/T_{lg} is set to 0.4, t_{cen}/tₘᵢₙ is set to 5, and the combined particle concentration is of type A (with efficiency of 100).

FIG. 11B illustrates an actual distribution (one-dot chained line) and an ideal distribution (solid line) of illuminance when t_{cen}/T_{lg} is set to 0.4, t_{cen}/tₘᵢₙ is set to 5, and the combined particle concentration is of type B (with efficiency of 98).

FIG. 11C illustrates an actual distribution (one-dot chained line) and an ideal distribution (solid line) of illuminance when t_{cen}/T_{lg} is set to 0.975, t_{cen}/tₘᵢₙ is set to 5, and the combined particle concentration is of type A (with efficiency of 100).

FIG. 11D illustrates an actual distribution (one-dot chained line) and an ideal distribution (solid line) of illuminance when t_{cen}/T_{lg} is set to 0.6, t_{cen}/tₘᵢₙ is set to 5, and the combined particle concentration is of type C (with efficiency of 92).

In Example 1-4, the illuminance distribution was calculated and the average of departure [%] from the ideal distribution, and the maximum value of departure [%] were calculated in the same way as in Example 1-1, except that the error pattern illustrated in FIG. 9C was added. The results are shown in Tables 9 and 10.

TABLE 9

| | Combined particle | t_{cen}/T_{lg} | | | | | |
|---|---|---|---|---|---|---|---|
| t_{cen}/tₘᵢₙ | concentration | 0.2 | 0.3 | 0.4 | 0.6 | 0.8 | 0.975 |
| 5 | A | 18.4 | 11.6 | 8.9 | 5.3 | 4.5 | 4.4 |
| | B | 12.5 | 8.0 | 5.7 | 3.8 | 3.6 | 2.6 |
| | C | 9.1 | 5.5 | 3.6 | 3.1 | 1.4 | 1.5 |
| 3 | A | — | — | — | — | — | — |
| | B | 15.3 | 10.2 | 7.6 | 5.2 | 3.4 | 3.3 |
| | C | 9.6 | 6.7 | 5.5 | 3.5 | 2.7 | 1.7 |
| 2 | A | — | — | — | — | — | — |
| | B | — | — | — | — | — | — |
| | C | 13.7 | 8.7 | 6.7 | 4.8 | 3.6 | 3.6 |

TABLE 10

| | Combined particle | t_{cen}/T_{lg} | | | | | |
|---|---|---|---|---|---|---|---|
| t_{cen}/tₘᵢₙ | concentration | 0.2 | 0.3 | 0.4 | 0.6 | 0.8 | 0.975 |
| 5 | A | 57.4 | 37.4 | 30.1 | 24.0 | 18.1 | 12.3 |
| | B | 34.7 | 25.2 | 17.8 | 14.7 | 11.0 | 9.7 |
| | C | 21.2 | 15.4 | 11.4 | 10.1 | 7.2 | 7.6 |
| 3 | A | — | — | — | — | — | — |
| | B | 39.8 | 29.3 | 24.0 | 16.3 | 13.6 | 10.0 |
| | C | 26.0 | 17.9 | 14.1 | 11.6 | 7.7 | 8.1 |
| 2 | A | — | — | — | — | — | — |
| | B | — | — | — | — | — | — |
| | C | 30.8 | 23.3 | 18.5 | 12.8 | 10.0 | 9.5 |

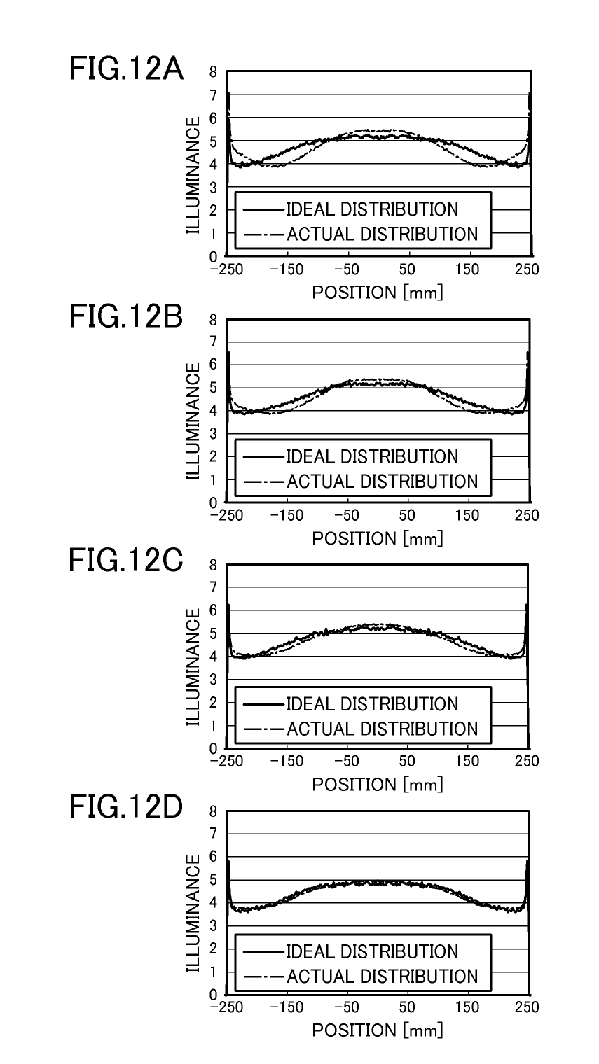

FIGS. 12A to 12D illustrate examples of the measurement result of the illuminance distribution of light exiting from a light exit surface of the light guide plate.

FIG. 12A illustrates an actual distribution (one-dot chained line) and an ideal distribution (solid line) of illuminance when t_{cen}/T_{lg} is set to 0.4, t_{cen}/tₘᵢₙ is set to 5, and the combined particle concentration is of type A (with efficiency of 100).

FIG. 12B illustrates an actual distribution (one-dot chained line) and an ideal distribution (solid line) of illuminance when t_{cen}/T_{lg} is set to 0.4, t_{cen}/tₘᵢₙ is set to 5, and the combined particle concentration is of type B (with efficiency of 98).

FIG. 12C illustrates an actual distribution (one-dot chained line) and an ideal distribution (solid line) of illuminance when t_{cen}/T_{lg} is set to 0.975, t_{cen}/tₘᵢₙ is set to 5, and the combined particle concentration is of type A (with efficiency of 100).

FIG. 12D illustrates an actual distribution (one-dot chained line) and an ideal distribution (solid line) of illuminance when t_{cen}/T_{lg} is set to 0.6, t_{cen}/tₘᵢₙ is set to 5, and the combined particle concentration is of type C (with efficiency of 92).

In even a thin light guide plate having a thickness of 4 mm or less and having a two-layer structure in which the variation of the actual thickness tends to increase due to the influence of thickness unevenness, it can be seen from the above-mentioned results of Examples 1-1 to 1-4 that the average of departure of the actual illuminance distribution from the ideal distribution can be set to 5% or less and the maximum value of departure can be set to 18% or less by setting t_{cen}/T_{lg} to be equal to or more than 0.3 and equal to or less than 1. That is, it can be seen that by setting t_{cen}/T_{lg} in the above range, the robustness can be improved, the light use efficiency can be improved, the influence of thickness unevenness (dimensional tolerance) of the light guide plate can be reduced, and even when the thickness of the light guide plate is uneven, the illuminance distribution does not depart greatly from a desired distribution and thus it is possible to prevent occurrence of unevenness. Therefore, it can be seen that in order to obtain a light guide plate capable of realizing a desired illuminance distribution, it is not necessary to reduce the dimensional tolerance and thus it is possible to stably and easily manufacture the light guide plate.

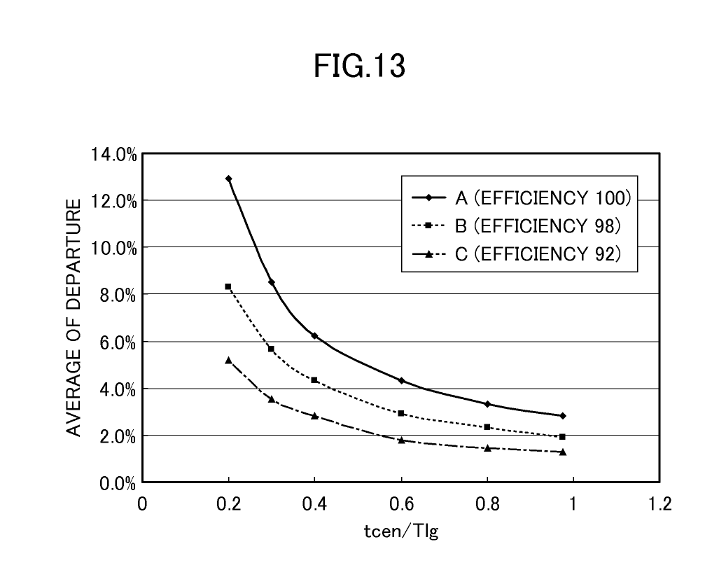

A graph illustrating the relationship between t_{cen}/T_{lg} and the average of departure in Example 1-1 is shown in FIG. 13. In FIG. 13, a case of combined particle concentration A (with efficiency of 100) is indicated by a solid line, a case of combined particle concentration B (with efficiency of 98) is indicated by a dotted line, and a case of combined particle concentration C (with efficiency of 92) is indicated by a one-dot chained line.

As illustrated in FIG. 13, it can be seen that by setting t_{cen}/T_{lg} to 0.6 or more, the average of departure can be set to 5% or less in even the case of combined particle concentration A (with efficiency of 100). That is, it is preferable that t_{cen}/T_{lg} be set to 0.6 or more, in that the robustness can be further improved.

It can also be seen that the larger t_{cen}/tₘᵢₙ becomes, the smaller the average of departure and the maximum value of departure become and the smaller the illuminance unevenness becomes. It can also be seen that t_{cen}/tₘᵢₙ is preferably set to 2, in that it is possible to further reduce the influence of thickness unevenness, to further stably emit light having high light use efficiency and small luminance unevenness, and thus to obtain a middle-high or bell-shaped brightness distribution. When t_{cen}/tₘᵢₙ becomes excessively large, the smallest thickness tₘᵢₙ becomes excessively small and thus t_{cen}/tₘᵢₙ is preferably set to 20 or less and more preferably set to 10 or less.

In this example, the particle diameter of scattering particles was set to 4.5 μm, but the present invention is not limited to this particle diameter. The particle diameter range of scattering particles is preferably set to from 4.5 μm to 12 μm.

The preferable range of the distance from the light incidence surfaces to the positions of the smallest thickness tₘᵢₙ in the direction perpendicular to the light incidence surfaces is proportional to the size of the light guide plate. Specifically, a range of 6.4 mm to 22.2 mm is preferably set for a light guide plate corresponding to 20 inches, a range of 12.8 mm to 44.4 mm is preferably set for a light guide plate corresponding to 40 inches, and a range of 32.1 mm to 110.9 mm is preferably set for a light guide plate corresponding to 100 inches.

It can be seen that the higher the particle concentration (combined particle concentration) becomes, the higher the light use efficiency becomes, but the robustness becomes lower when the combined particle concentration becomes higher. That is, it can be seen that in order to enhance the light use efficiency and to improve the robustness, the particle diameter is preferably set in a predetermined range. This point will be described later in detail.

In the light guide plate 30 illustrated in FIG. 2, light exiting from the light source units 28 and incident from the first light incidence surface 30c and the second light incidence surface 30d is scattered by a scattering material (scattering particles) included in the light guide plate 30, passes through the inside of the light guide plate 30, and is emitted from the light exit surface 30a directly or after being reflected by the rear surface 30b. At this time, some light may leak from the rear surface 30b, but the leaked light is reflected by a reflecting plate 34 disposed on the rear surface 30b side of the light guide plate 30 and is incident on the inside of the light guide plate 30 again. The reflecting plate 34 will be described later in detail.

As a method of manufacturing a thin (0.3 mm to 4 mm) light guide plate according to the invention in which scattering particles having different particle concentrations are kneaded and dispersed in two layers, a two-layer extrusion molding method or the like can be used in addition to a method which involves forming a base film containing scattering particles as a first layer using an extrusion molding method, applying a monomer resin liquid (liquid of a transparent resin) having scattering particles dispersed therein to the formed base film, irradiating the monomer resin liquid with ultraviolet light or visible light to cure the monomer resin liquid to form a second layer with a desired particle concentration, thereby obtaining a film-like light guide plate.

The light guide plate 30 illustrated in the drawing has such a shape that the thickness of the second layer smoothly varies so as to be the largest at the center of the light guide plate, to decrease as it goes from the center toward the light incidence surfaces, and to increase in the vicinity of the light incidence surfaces, but the present invention is not limited to this shape.

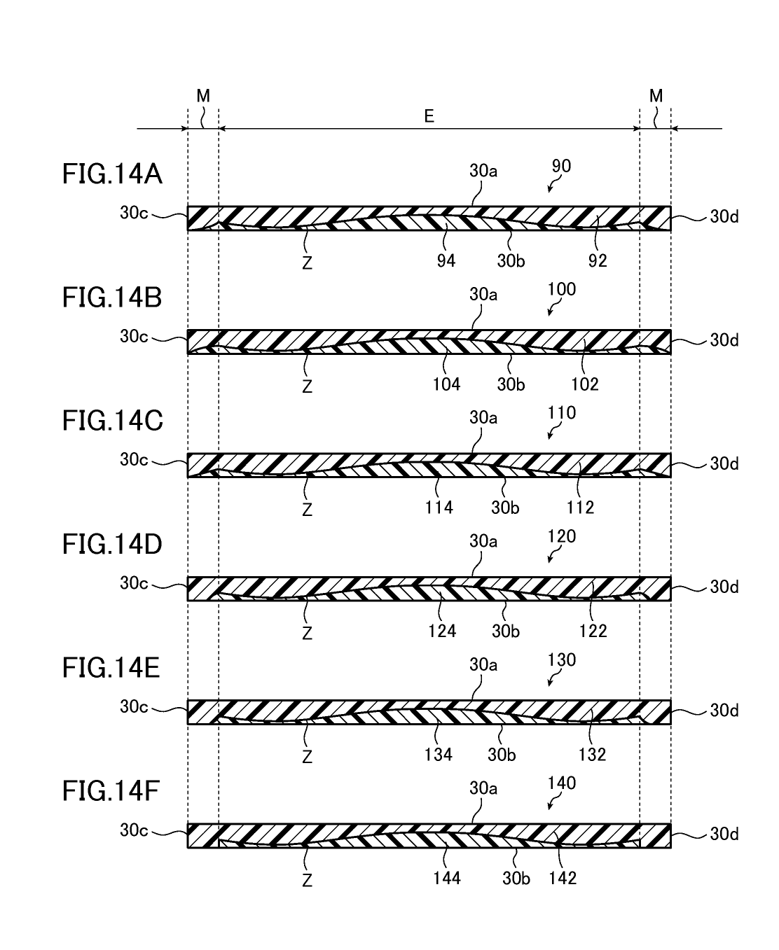

FIG. 14A is a schematic diagram illustrating another example of the light guide plate according to the present invention.

A light guide plate 90 illustrated in FIG. 14A has the same configuration as the light guide plate 30 illustrated in FIG. 3B, except that the shape of the interface z between the first layer and the second layer is changed. Accordingly, the same elements will be referenced by the same reference numerals and the differences will be mainly described below.

The light guide plate 90 shown in FIG. 14A includes a first layer 92 and a second layer 94 having a particle concentration higher than that of the first layer 92. The interface z between the first layer 92 and the second layer 94 of the light guide plate 90 smoothly varies so that the second layer has the largest thickness at the bisector α of the light exit surface 30a (that is, at the center of the light exit surface) and the thickness of the second layer 94 decreases up to the smallest thickness tₘᵢₙ (the smallest thickness in the effective screen area E) toward the first light incidence surface 30c and the second light incidence surface 30d, and continuously varies so that the thickness of the second layer once increases in the vicinity of the first light incidence surface 30c and the second light incidence surface 30d and then decreases again.

Specifically, the interface z includes a curved surface which is convex to the light exit surface 30a at the center of the light guide plate 90, concave curved surfaces which are smoothly connected to the convex curved surface, and concave curved surfaces which are respectively connected to the concave curved surfaces and connected to ends of the light incidence surfaces 30c and 30d on the rear surface 30b side. The thickness of the second layer 94 is 0 on the light incidence surfaces 30c and 30d.

By thus causing the thickness of the second layer 94 having a higher particle concentration of scattering particles than that of the first layer 92 to continuously vary so as to have a first local maximum value showing an increased thickness in the vicinity of the light incidence surfaces and a second local maximum value showing the largest thickness at the center of the light guide plate, the combined particle concentration of scattering particles varies to have the first local maximum value in the vicinity of the first and the second light incidence surfaces (30c and 30d) and the second local maximum value larger than the first local maximum value.

That is, the profile of the combined particle concentration shows a curve which varies to have the second local maximum value which is the largest at the center of the light guide plate 30, to have the local minimum value at the positions away from the center by about two-thirds of the distance from the center to the light incidence surfaces (30c and 30d) on both sides thereof in the illustrated example, and to have the first local maximum value on the side closer to the light incidence surfaces than the positions of the local minimum value.

Here, the first local maximum value of the thickness (combined particle concentration) of the second layer 94 is positioned in the vicinity of the boundary position of an opening 44a of the upper housing 44. The region covered with the frame part for forming the opening 44a of the upper housing 44 does not contribute to emission of light as the backlight unit 20.

That is, since the regions from the light incidence surfaces 30c and 30d to the positions of the first local maximum values are located in the frame part for forming the opening 44a of the upper housing 44, the regions do not contribute to the emission of light as the backlight unit 20. That is, the regions from the light incidence surfaces 30c and 30d to the positions of the first local maximum values are so-called mixing zones M for diffusing light incident from the light incidence surfaces. The region closer to the center of the light guide plate than the mixing zones M, that is, the region corresponding to the opening 44a of the upper housing 44, is an effective screen area E and is a region contributing to the emission of light as the backlight unit 20. That is, in the effective screen area E, the light guide plate 90 has an interface z having the same shape as the interface z of the light guide plate 30 illustrated in FIG. 3B and has the mixing zones M in the regions on both sides thereof (end portions on the light incidence surface sides).

By thus setting the thickness of the second layer of the light guide plate 90 so that the concentration thereof has the second local maximum value which is the largest at the center, even a large and thin light guide plate can send light incident from the light incidence surfaces 30c and 30d to far positions from the light incidence surfaces 30c and 30d, thereby obtaining the luminance distribution of outgoing light having a middle-high shape.

By adjusting the combined particle concentration so as to have the first local maximum value in the vicinity of the light incidence surfaces 30c and 30d, it is possible to sufficiently diffuse light incident from the light incidence surfaces 30c and 30d in the vicinity of the light incidence surfaces and thus to prevent a bright line (dark line, unevenness) due to the arrangement interval of the light sources or the like from being visualized in outgoing light exiting from the vicinity of the light incidence surfaces.

By adjusting the regions closer to the light incidence surfaces 30c and 30d than the positions of the first local maximum value of the combined particle concentration so as to have a combined particle concentration lower than the first local maximum value, it is possible to reduce return light exiting from the light incidence surfaces after it once enters the light guide plate or outgoing light from the regions (mixing zones M) in the vicinity of the light incidence surfaces which is not used because they are covered with the housing and thus to improve use efficiency of light exiting from the effective region (effective screen area E) of the light exit surface.

In the present invention, the thickness t_{cen} at the center of the second layer 94 of the light guide plate 90 and the thickness T_{lg} of the light guide plate 90 satisfy 0.3 mm≦T_{lg}≦4 mm and 0.3≦t_{cen}/T_{lg}≦1. Accordingly, even a light guide plate having the above-mentioned large and thin shape can be less affected by the thickness unevenness and can stably emit light having high light use efficiency and small luminance unevenness, thereby obtaining a middle-high or bell-shaped brightness distribution.

In the light guide plate 90 illustrated in the drawing, the regions of the interface surface z from the positions of the first local maximum value to the light incidence surfaces 30c and 30d, that is, the mixing zones M, are curved surfaces which are concave to the light exit surface 30a, but the present invention is not limited to this example.

FIGS. 14B to 14F are schematic diagrams illustrating other examples of the light guide plate according to the present invention.

Light guide plates 100, 110, 120, 130, and 140 illustrated in FIGS. 14B to 14F have the same configuration as the light guide plate 90 illustrated in FIG. 14A, except that the thicknesses of the first layer and the second layer in the mixing zones M, that is, the shape of the interface z in the mixing zones M, are changed. Accordingly, the same elements will be referenced by the same reference numerals and the differences will be mainly described below.

The light guide plate 100 shown in FIG. 14B includes a first layer 102 and a second layer 104 having a particle concentration higher than that of the first layer 102. In the mixing zones M, the interface z between the first layer 102 and the second layer 104 includes curved surfaces which are convex to the light exit surface 30a and which are connected to the positions of the first local maximum value and to ends of the light incidence surfaces 30c and 30d on the rear surface side 30b.

The light guide plate 110 shown in FIG. 14C includes a first layer 112 and a second layer 114 having a particle concentration higher than that of the first layer 112. In the mixing zones M, the interface z between the first layer 112 and the second layer 114 includes flat surfaces which are connected to the positions of the first local maximum value and to ends of the light incidence surfaces 30c and 30d on the rear surface side 30b.

The light guide plate 120 shown in FIG. 14D includes a first layer 122 and a second layer 124 having a particle concentration higher than that of the first layer 122. In the mixing zones M, the interface z between the first layer 122 and the second layer 124 includes curved surfaces which are convex to the light exit surface 30a and which are connected to the positions of the first local maximum value and to the rear surface 30b substantially at the centers of the mixing zones M.

The light guide plate 130 shown in FIG. 14E includes a first layer 132 and a second layer 134 having a particle concentration higher than that of the first layer 132. In the mixing zones M, the interface z between the first layer 132 and the second layer 134 includes curved surfaces which are concave to the light exit surface 30a and which are connected to the positions of the first local maximum value and to the rear surface 30b substantially at the centers of the mixing zones M.

The light guide plate 140 illustrated in FIG. 14F includes a first layer 142 and a second layer 144 having a particle concentration higher than that of the first layer 142. The light guide plate 140 in the mixing zones M includes only the first layer 142. That is, the interface z has a shape having planar surfaces parallel to the light incidence surfaces 30c and 30d at the positions of the first local maximum value.

As in the light guide plates illustrated in FIGS. 14B to 14F, the shape of the interface z is formed so that the thickness of the second layer decreases from the positions of the first local maximum value toward the light incidence surfaces 30c and 30d. Accordingly, since the combined particle concentration in the regions (mixing zones M) from the positions of the first local maximum value to the light incidence surfaces 30c and 30d is set to a combined particle concentration lower than the first local maximum value, it is possible to reduce return light exiting from the light incidence surfaces after it once enters the light guide plate or outgoing light from the regions (mixing zones M) in the vicinity of the light incidence surfaces which is not used because they are covered with the housing and thus to improve use efficiency of light exiting from the effective region (effective screen area E) of the light exit surface.

In a cross-section perpendicular to the longitudinal direction of the light incidence surfaces, the concave and convex curved surfaces constituting the interface z may be curves expressed as a part of a circle or an ellipse, a quadratic curve, a curve expressed as a polynomial expression, or a curve in which these curves are combined.

### Example 2

In Example 2, normalized illuminance distributions of outgoing light were calculated by computer simulation using the light guide plate 140 illustrated in FIG. 14F.

In Example 2, the illuminance distribution when t_{cen}/T_{lg} was 0.4, t_{cen}/tₘᵢₙ was 5, and the combined particle concentration was of type A (with efficiency of 100) was calculated in the same way as in Example 1, except that the thickness distribution of the second layer 144 was changed.

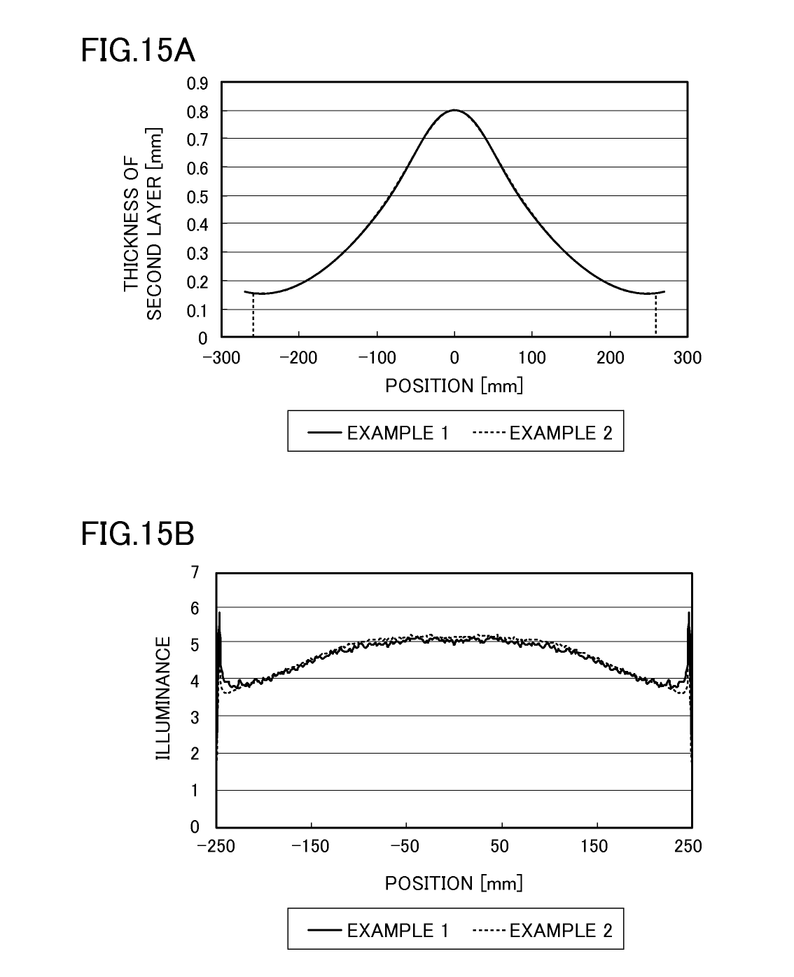

In FIG. 15A, the ideal thickness of the second layer in Example 1 is indicated by a solid line and the ideal thickness of the second layer in Example 2 is indicated by dotted lines. FIG. 15B illustrates illuminance distributions of light exiting from the light guide plates having the thickness profiles illustrated in FIG. 15A.

As illustrated in FIG. 15A, the ideal thickness of the second layer in Example 2 has the same profile as in Example 1, except that the thickness is 0 in the vicinity of the light incidence surfaces (mixing zones M).

As illustrated in FIG. 15B, the ideal distribution of the illuminance of the light guide plate of Example 2 is lowered in the vicinity of the light incidence surfaces and is raised at the center, compared with Example 1. That is, in the light guide plate of Example 2, it can be seen that it is possible to reduce an amount of light emitted from the mixing zones M, to increase an amount of light emitted from the effective screen area E, and to improve substantial light use efficiency, compared with Example 1.

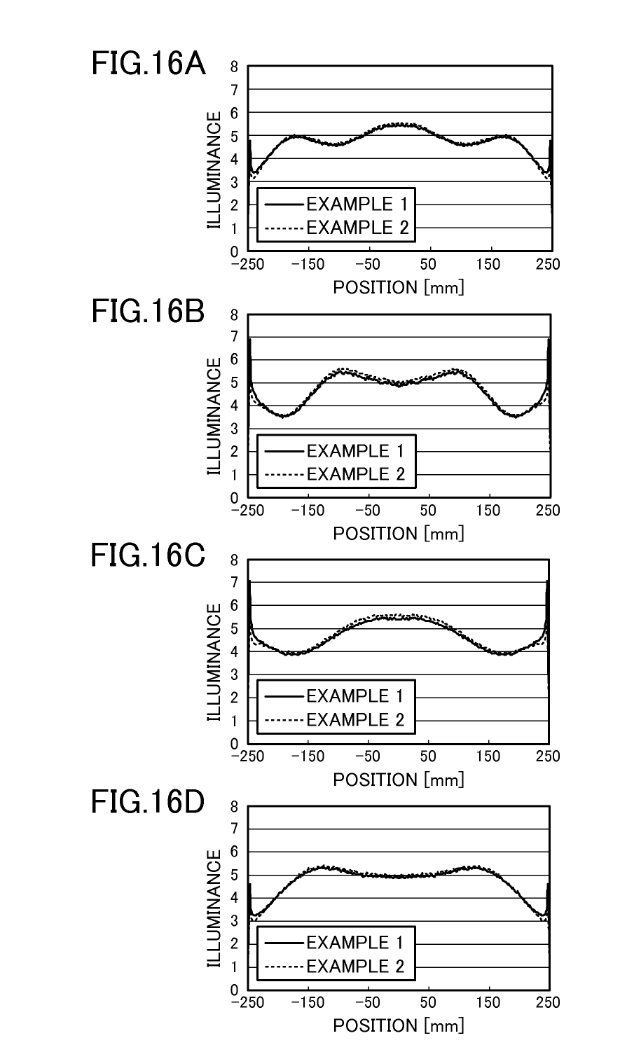

Next, in Example 2, the illuminance distributions (actual distributions) of outgoing light when the error patterns illustrated in FIG. 6 and FIGS. 9A to 9C were added to the thickness of the light guide plate were calculated. The results are illustrated in FIG. 16A to 16D.

FIG. 16A illustrates actual distributions of illuminance when the error pattern illustrated in FIG. 6 is added, where the actual distribution of Example 1 is indicated by a solid line and the actual distribution of Example 2 is indicated by a dotted line. As illustrated in FIG. 16A, the actual distribution of illuminance of Example 2 has the same tendency as in Example 1, except that the central portion is raised to improve light use efficiency, compared with Example 1.

Similarly, FIGS. 16B to 16D illustrate actual distributions of illuminance when the error patterns illustrated in FIGS. 9B, 9C, and 9A are added. In FIGS. 16B to 16D, the actual distributions of Example 2 have the same tendency as in Example 1, except that the central portion is raised to improve light use efficiency, compared with Example 1.

Accordingly, in even the light guide plates having a two-layered structure illustrated in FIGS. 14A to 14F, by setting t_{cen}/T_{lg} to be equal to or more than 0.3 and equal to or less than 1, it is possible to improve robustness, to improve light use efficiency, and to reduce the influence of thickness unevenness (dimensional tolerance) of the light guide plates. Accordingly, even when the thickness of a light guide plate is uneven, it is possible to prevent the illuminance distribution from greatly departing from a desired distribution and to prevent a difference from occurring therebetween.

In the examples illustrated in the drawings, the light exit surface 30a is a flat surface, but the present invention is not limited to this configuration and the light exit surface may be a concave surface. By forming the light exit surface as a concave surface, it is possible to prevent the light guide plate from warping to the light exit surface side and to prevent the light guide plate from coming in contact with the liquid crystal display panel 12, when the light guide plate extends or contracts due to heat or moisture.

Next, the optical member unit 32 will be described below.

The optical member unit 32 is used to reduce luminance unevenness and illuminance unevenness of illumination light exiting from the light exit surface 30a of the light guide plate 30 to allow the light to exit from the light exit surface 24a of the lighting device main body 24. As illustrated in FIG. 2, the optical member unit 32 includes a diffusing sheet 32a that diffuses illumination light exiting from the light exit surface 30a of the light guide plate 30 to reduce the luminance unevenness and the illuminance unevenness, a prism sheet 32b in which micro-prism arrays parallel to edges where the light incidence surfaces 30c and 30d, and the light exit surface 30a meet each other, and a diffusing sheet 32c that diffuses illumination light exiting from the prism sheet 32b to reduce the luminance unevenness and the illuminance unevenness.

The diffusing sheets 32a and 32c and the prism sheet 32b are not particularly limited and known diffusing sheets or prism sheets can be used. For example, optical sheets disclosed in paragraphs [0028] to [0033] of JP 2005-234397 A can be employed.

In this embodiment, the optical member unit is constructed by two diffusing sheets 32a and 32c and one prism sheet 32b disposed between the two diffusing sheets, but the arrangement order or the number of prism sheets and diffusing sheets is not particularly limited. In addition, the prism sheet and the diffusing sheets are not particularly limited, and various optical members can be used as long as they can further reduce the luminance unevenness and the illuminance unevenness of illumination light exiting from the light exit surface 30a of the light guide plate 30.

For example, a transmittance adjusting member in which plural transmittance adjusters formed of diffusing reflectors are arranged depending on the luminance unevenness and the illuminance unevenness may also be used as the optical member in addition to or instead of the diffusing sheets and the prism sheet. The optical member unit may be formed in a two-layer structure using one prism sheet and one diffusing sheet or using only two diffusing sheets.

Next, the reflecting plate 34 of the lighting device main body 24 will be described below.

The reflecting plate 34 is disposed to reflect light leaking from the rear surface 30b of the light guide plate 30 and to cause the reflected light to enter the light guide plate 30 again and can improve light use efficiency. The reflecting plate 34 is formed in a shape corresponding to the rear surface 30b of the light guide plate 30 so as to cover the rear surface 30b. In this embodiment, as shown in FIG. 2, since the rear surface 30b of the light guide plate 30 is a planar surface, that is, has a linear shape in cross-section, the reflecting plate 34 is also formed in a shape corresponding thereto.

The reflecting plate 34 may be formed of any material as long as it can reflect light leaking from the rear surface 30b of the light guide plate 30. The reflecting plate 34 may be formed, for example, of a resin sheet produced by kneading a filler with PET or PP (polypropylene) and then drawing the resultant mixture to form voids therein for increased reflectance; a sheet with a specular surface formed by, for example, aluminum vapor deposition on the surface of a transparent or white resin sheet; a metal foil such as an aluminum foil or a resin sheet carrying a metal foil; or a thin metal sheet having a sufficient reflectivity on the surface.

Upper light guide reflecting plates 36 are disposed respectively to cover the light source units 28 and the end portions of the light exit surface 30a of the light guide plate 30 (an end portion on the side of the first light incidence surface 30c and an end portion on the side of the second light incidence surface 30d) between the light guide plate 30 and the diffusing sheet 32a, that is, on the side of the light exit surface 30a of the light guide plate 30. In other words, the upper light guide reflecting plates 36 are disposed in the direction parallel to the optical axis direction so as to cover areas each including a part of the light exit surface 30a of the light guide plate 30 and a part of the light source support 52 of the light source unit 28. That is, the two upper light guide reflecting plates 36 are disposed at both end portions of the light guide plate 30.

By arranging the upper light guide reflecting plates 36 in this way, it is possible to prevent light emitted from the light source units 28 from failing to enter the light guide plate 30 and leaking to the light exit surface 30a side.

Accordingly, it is possible to allow light emitted from the light source units 28 to efficiently enter the light guide plate 30 through the first light incidence surface 30c and the second light incidence surface 30d, thereby improving light use efficiency.

Lower light guide reflecting plates 38 are disposed on the side of the rear surface 30b of the light guide plate 30 so as to cover a part of the light source units 28. The ends of the lower light guide reflecting plates 38 close to the center of the light guide plate 30 are connected to the reflecting plate 34.

Here, the upper light guide reflecting plates 36 and the lower light guide reflecting plates 38 can be formed of various materials used in the reflecting plate 34.

By providing the lower light guide reflecting plates 38, it is possible to prevent light emitted from the light source units 28 from failing to enter the light guide plate 30 and leaking to the side of the rear surface 30b of the light guide plate 30.

Accordingly, it is possible to allow light emitted from the light source units 28 to efficiently enter the light guide plate 30 through the first light incidence surface 30c and the second light incidence surface 30d, thereby improving light use efficiency.

In this embodiment, the reflecting plate 34 is connected to the lower light guide reflecting plates 38, but the present invention is not limited to this configuration and the reflecting plate and the lower light guide reflecting plates may be formed as different members.

The shapes and the widths of the upper light guide reflecting plates 36 and the lower light guide reflecting plates 38 are not particularly limited, as long as they can reflect light emitted from the light source unit 28 to the side of the first light incidence surface 30c or the second light incidence surface 30d, allow the light emitted from the light source unit 28 to impinge on the first light incidence surface 30c or the second light incidence surface 30d, and can guide the light having entered the light guide plate 30 to the central side of the light guide plate 30.

In this embodiment, the upper light guide reflecting plates 36 are disposed between the light guide plate 30 and the diffusing sheet 32a, but the arrangement positions of the upper light guide reflecting plates 36 are not limited to this. The upper light guide reflecting plates may be disposed between sheet-like members constituting the optical member unit 32 or may be disposed between the optical member unit 32 and the upper housing 44.

Next, the housing 26 will be described below.

As shown in FIG. 2, the housing 26 receives and supports the lighting device main body 24 and holds and secures the lighting device main body 24 from the side closer to the light exit surface 24a and the side closer to the rear surface 30b of the light guide plate 30. The housing 26 has the lower housing 42, the upper housing 44, the folded members 46, and the support members 48.

The lower housing 42 is open at the top and has a shape formed by a bottom section and lateral sections provided upright on four sides of the bottom section. In brief, the lower housing 42 has a substantially rectangular box shape of which one surface is open. As shown in FIG. 2, the lower housing 42 supports the lighting device main body 24 received therein from above on the bottom section and the lateral sections and covers the surfaces of the lighting device main body 24 other than the light exit surface 24a, that is, the opposite surface of the lighting device main body 24 to the light exit surface 24a (rear surface) and the lateral surfaces thereof.

The upper housing 44 has the shape of a rectangular box which has at the top the rectangular opening 44a smaller than the rectangular light exit surface 24a of the lighting device main body 24 and which is open at the bottom.

As shown in FIG. 2, the upper housing 44 is disposed to cover the lighting device main body 24, the lower housing 42 receiving the main body, and the four lateral sections from above the lighting device main body 24 and the lower housing 42 (from the light exit surface side).

The folded member 46 has a cross-sectional shape which is a fixed concave (U) shape. That is, the folded member is a rod-like member of which the shape of the cross-section perpendicular to the direction in which the folded member extends is a U-shape.

As shown in FIG. 2, each folded member 46 is inserted between the side surface of the lower housing 42 and the side surface of the upper housing 44, and the outer surface of one parallel portion of the U shape is joined to the side surface of the lower housing 42 and the outer surface of the other parallel portion is joined to the side surface of the upper housing 44.

Here, as the method of joining the folded members 46 to the lower housing 42 and the method of joining the folded members 46 to the upper housing 44, various known methods such as a method using bolts and nuts and a method using an adhesive can be used.

By disposing the folded members 46 between the lower housing 42 and the upper housing 44 in this way, it is possible to enhance the rigidity of the housing 26 and thus to prevent the light guide plate 30 from warping. Accordingly, for example, when a light guide plate used is capable of efficiently emitting light with no luminance unevenness and no illuminance unevenness or with small luminance unevenness and small illuminance unevenness but is more likely to warp, it is possible to more reliably correct warp or to more reliably prevent the light guide plate from warping, thereby emitting light with no luminance unevenness and no illuminance unevenness or with reduced luminance unevenness and reduced illuminance unevenness from the light exit surface.

Various materials such as metal and resin can be used for the upper housing, the lower housing, and the folded members of the housing. A material having small weight and high strength can be preferably used as the material.

In this embodiment, the folded members are formed as independent members, but may be formed as a unified body with the upper housing or the lower housing. The folded members may not be provided.

The support members 48 are rod-like members each having throughout its length an identical shape in cross-section perpendicular to the direction in which they extend.

As shown in FIG. 2, the support members 48 are disposed between the lower housing 42 and the reflecting plate 34, more specifically between the lower housing 42 and the reflecting plate 34 at the positions corresponding to the end portion on the side of the first light incidence surface 30c and the end portion on the side of the second light incidence surface 30d of the rear surface 30b of the light guide plate 30. The support members 48 fix the light guide plate 30 and the reflecting plate 34 to the lower housing 42, and support them.

By supporting the reflecting plate 34 using the support members 48, it is possible to bring the light guide plate 30 and the reflecting plate 34 into close contact with each other. It is also possible to fix the light guide plate 30 and the reflecting plate 34 to the lower housing 42 at their predetermined positions.

In this embodiment, the support members are provided as independent members, but the support members are not limited to this configuration and may be formed as a unified body with the lower housing 42 or the reflecting plate 34. That is, protruding portions may be formed in a part of the lower housing 42 and the formed protruding portions may be used as the support members, or protruding portions may be formed in a part of the reflecting plate 34 and the formed protruding portions may be used as the support members.

The arrangement positions thereof are not particularly limited, and the support members can be disposed at any position between the reflecting plate and the lower housing. However, in order to stably hold the light guide plate, the support members are preferably disposed on the sides of the ends of the light guide plate, that is, in the vicinity of the first light incidence surface 30c and in the vicinity of the second light incidence surface 30d in this embodiment.

The shape of the support members 48 is not particularly limited, and the support members may have various shapes and may be formed of various materials. For example, plural support members may be arranged at predetermined intervals.

The support members may have a shape filling the entire space formed by the reflecting plate and the lower housing. That is, the surface on the side of the reflecting plate may have a shape contouring the reflecting plate and the surface on the side of the lower housing may have a shape contouring the lower housing. When the entire surface of the reflecting plate is thus supported by the use of the support members, it is possible to reliably prevent the light guide plate and the reflecting plate from being separated from each other and thus to prevent occurrence of luminance unevenness and illuminance unevenness by light reflected on the reflecting plate.

The function of the backlight unit 20 configured as described above will be described.

In the backlight unit 20, light emitted from the light source units 28 disposed at both ends of the light guide plate 30 enters the light guide plate 30 through the light incidence surfaces (the first light incidence surface 30c and the second light incidence surface 30d). The light having entered through the respective surfaces is scattered by the scattering material contained in the light guide plate 30 as the light travels inside the light guide plate 30 and is emitted from the light exit surface 30a directly or after being reflected by the rear surface 30b. At this time, a part of the light leaking from the rear surface is reflected by the reflecting plate 34 and enters the light guide plate 30 again.

In this way, the light emitted from the light exit surface 30a of the light guide plate 30 passes through the optical member unit 32 and is emitted from the light exit surface 24a of the lighting device main body 24, thereby illuminating the liquid crystal display panel 12.

The liquid crystal display panel 12 uses the drive unit 14 to control the light transmittance according to the position so as to display characters, figures, images and the like on the surface of the liquid crystal display panel 12.

In the above-mentioned embodiment, double-side incidence in which two light source units are disposed on two light incidence surfaces of the light guide plate has been used, but the present invention is not limited to this configuration, and single-side incidence in which only one light source unit is disposed on one light incidence surface of the light guide plate may be used. By reducing the number of light source units, it is possible to reduce the number of components and thus to reduce cost.

In case of the single-side incidence, a light guide plate in which the shape of the interface z is asymmetric may be used. For example, a light guide plate which has one light incidence surface and of which the shape of the second layer is asymmetric such that the thickness of the second layer of the light guide plate is the maximum at a position more distant from the light incidence surface than the bisector of the light exit surface may be used.

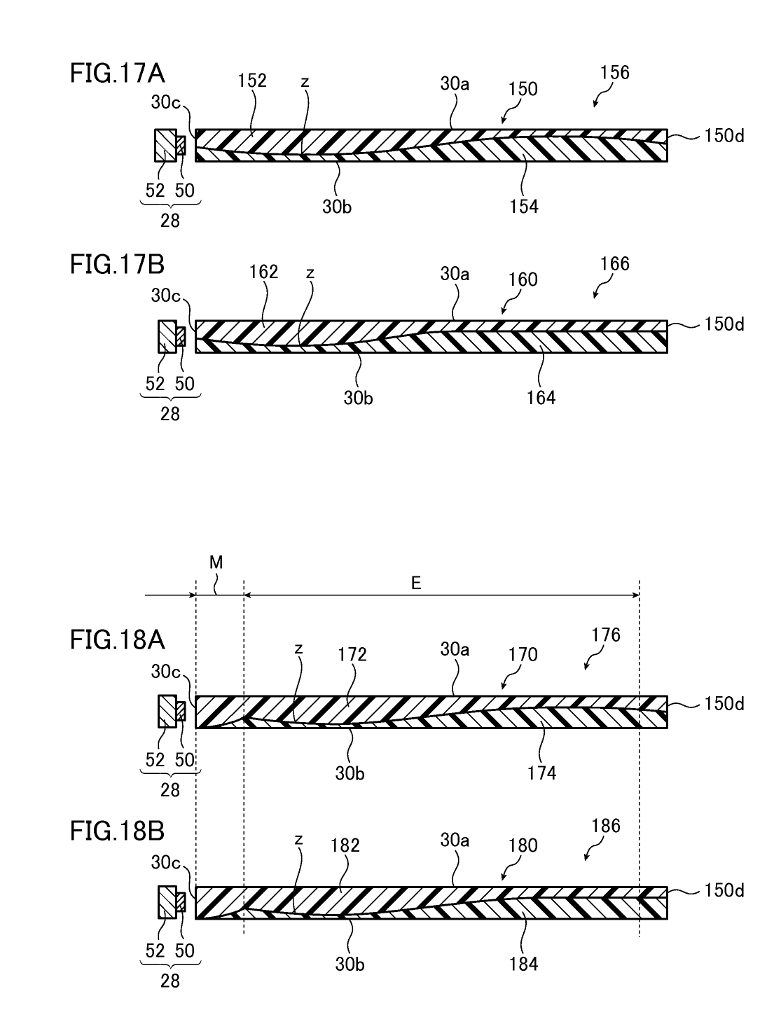

FIG. 17A is a schematic cross-sectional view illustrating a part of the backlight unit using another example of the light guide plate according to the present invention. A backlight unit 156 shown in FIG. 17A has the same configuration as the backlight unit 20, except that a light guide plate 150 is used instead of the light guide plate 30 and only one light source unit 28 is used. Accordingly, the same elements will be referenced by the same reference numerals and the differences will be mainly described below.

A backlight unit 156 shown in FIG. 17A comprises the light guide plate 150 and a light source unit 28 disposed to face a first light incidence surface 30c of the light guide plate 150.

The light guide plate 150 includes the first light incidence surface 30c which is a surface disposed to face the light source unit 28 and a side surface 150d which is the surface opposite to the first light incidence surface 30c.

The light guide plate 150 includes a first layer 152 on the side of a light exit surface 30a and a second layer 154 on the side of a rear surface 30b. The interface z between the first layer 152 and the second layer 154 smoothly varies so that the thickness of the second layer 154 once decreases up to the smallest thickness tₘᵢₙ from the first light incidence surface 30c toward the side surface 150d, and the thickness of the second layer 154 increases up to the largest thickness and then decreases on the side of the side surface 150d, when viewed in a cross-section perpendicular to the length direction of the first light incidence surface 30c.

Specifically, the interface z includes a curved surface which is concave to the light exit surface 30a on the side of the first light incidence surface 30c of the light guide plate 150 and a convex curved surface, which is smoothly connected to the concave curved surface and is located on the side of the side surface 150d.

That is, the profile of the combined particle concentration shows a curve varying to have a local minimum value on the side of the light incidence surface and to have a local maximum value on the side of the side surface.

In case of the single-side incidence thus using only one light source unit, by setting the combined particle concentration (the thickness of the second layer 154) of the light guide plate 150 to a concentration having a local minimum value at a position close to the first light incidence surface 30c and having a local maximum value on the side closer to the side surface 150d than the central portion, light incident from the light incidence surface can be sent to a position farther from the light incidence surface in even a large and thin light guide plate, thereby obtaining the luminance distribution of outgoing light having a middle-high shape.

Further, by setting the combined particle concentration in the vicinity of the light incidence surface to be higher than the local minimum value, it is possible to satisfactorily diffuse light incident from the light incidence surface in the vicinity of the light incidence surface and thus to prevent a bright line (dark line, unevenness) due to the arrangement interval of the light sources or the like from being visualized in outgoing light exiting from the vicinity of the light incidence surface.

In the present invention, the thickness T_{cen} at the center of the second layer 154 of the light guide plate 150 and the thickness T_{lg} of the light guide plate 150 satisfy 0.3 mm≦T_{lg}≦4 mm and 0.3≦t_{cen}/T_{lg}1. Accordingly, even a light guide plate having a large and thin shape can be less affected by the thickness unevenness and can stably emit light having high light use efficiency and small luminance unevenness, thereby obtaining a middle-high or bell-shaped brightness distribution.

The light guide plate 150 illustrated in FIG. 17A is configured such that the thickness of the second layer 154 in the direction perpendicular to the light incidence surface 30c decreases from the position of the local maximum value toward the side surface 150d, but the present invention is not limited to this configuration. As in a light guide plate 160 illustrated in FIG. 17B, the thickness of the second layer 164 may be set to a constant thickness from the position of the local maximum value to the side surface 150d.

The light guide plates illustrated in FIGS. 17A and 17B are configured such that the thickness of the second layer decreases and then increases as it goes far away from the light incidence surface, but the present invention is not limited to this configuration.

Backlight units 176 and 186 illustrated in FIGS. 18A and 18B have the same configuration as the backlight unit 156, except that the shape of the interface z of the light guide plate 150 is changed in the backlight unit 156. Accordingly, the same elements will be referenced by the same reference numerals in the following description and the differences will be mainly described below.

The backlight unit 176 illustrated in FIG. 18A includes a light guide plate 170 and a light source unit 28 disposed to face a first light incidence surface 30c of the light guide plate 170.

The light guide plate 170 includes a first layer 172 on the side of a light exit surface 30a and a second layer 174 on the side of a rear surface 30b. The interface z between the first layer 172 and the second layer 174 continuously varies so that the thickness of the second layer 174 increases from the first light incidence surface 30c toward a side surface 150d, the thickness of the second layer 174 once smoothly decreases up to the smallest thickness tₘᵢₙ, and then the thickness of the second layer 174 smoothly increases again up to the largest thickness and decreases again on the side of the side surface 150d, when viewed in a cross-section perpendicular to the length direction of the first light incidence surface 30c.

Specifically, the interface z includes a curved surface convex to the light exit surface 30a on the side of the side surface 150d, a concave curved surface smoothly connected to the convex curved surface, and a concave curved surface connected to the concave curved surface and connected to an end of the first light incidence surface 30c on the side of the rear surface 30b. The thickness of the second layer 174 is 0 on the light incidence surface 30c.

That is, the combined particle concentration of scattering particles (the thickness of the second layer) varies to have a first local maximum value in the vicinity of the first light incidence surface 30c and a second local maximum value larger than the first local maximum value on the side closer to the side surface 150d than the center of the light guide plate.

Although not illustrated in the drawing, the position of the first local maximum value of the combined particle concentration of the light guide plate 150 is located at the boundary of the opening of the housing, and the region from the first light incidence surface 30c to the position of the first local maximum value is a so-called mixing zone M for diffusing light incident from the light incidence surface.

A light guide plate 180 of the backlight unit 186 illustrated in FIG. 18B has the same shape as the light guide plate 170, except that the thickness of a second layer 184 is set to a constant thickness from the position of the second local maximum value to a side surface 150d.

In the present invention, the thicknesses T_{cen} at the center of the second layers in the light guide plates 170 and 180 and the thicknesses T_{lg} of the light guide plates satisfy 0.3 mm≦T_{lg}≦4 mm and 0.3≦t_{cen}/T_{lg}≦1. Accordingly, even a light guide plate having a large and thin shape as illustrated in FIGS. 18A and 18B can be less affected by the thickness unevenness and can stably emit light having high light use efficiency and small luminance unevenness, thereby obtaining a middle-high or bell-shaped brightness distribution.

### Example 3

In Example 3, normalized illuminance distributions of outgoing light were calculated by computer simulation while variously changing the specification of the light guide plate 150 illustrated in FIG. 17A.

In Example 3, a reflecting plate facing the side surface 150d was disposed to allow light exiting from the side surface 150d to be incident on the light guide plate again.

In Example 3-1, a light guide plate 150 corresponding to a screen size of 40 inches was used. Specifically, the light guide plate 150 in which the length L_{lg} from the first light incidence surface 30c to the side surface 150d (the length of the light guide plate) was set to 539 mm, the thickness T_{lg} in the direction perpendicular to the light exit surface 30a (the thickness of the light guide plate) was set to 2 mm, and the particle diameter of scattering particles to be kneaded and dispersed therein was set to 4.5 μm was used.

In the light guide plate 150 as described above, three types (V1, V4, and V7) of combined particle concentrations having different middle-high degrees of outgoing light were calculated. The combined particle concentration having a distribution of outgoing light in which when the highest illuminance at the center was assumed to be 100, the lowest illuminance in the vicinity of the light incidence surface was 50 was defined as V1. The combined particle concentration having a distribution of outgoing light in which when the highest illuminance at the center was assumed to be 100, the lowest illuminance in the vicinity of the light incidence surface was 60 was defined as V4. The combined particle concentration having a distribution of outgoing light in which when the highest illuminance at the center was assumed to be 100, the lowest illuminance in the vicinity of the light incidence surface was 85 was defined as V7.

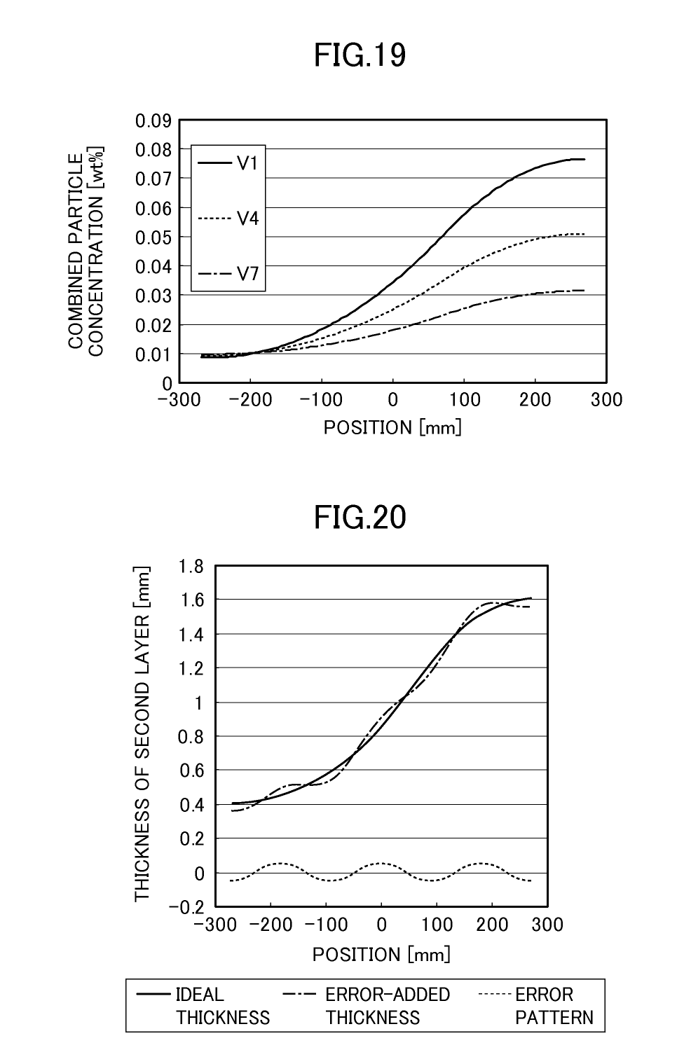

FIG. 19 illustrates a relationship between the combined particle concentration [wt %] and the position [mm] in the light guide plate. In FIG. 19, V1 is indicated by a solid line, V4 is indicated by a dotted line, and V7 is indicated by a one-dot chained line.

When the efficiency of the combined particle concentration V1 having the highest light use efficiency out of the three types was assumed to be 100, the efficiency of the combined particle concentration V4 was 99 and the efficiency of the combined particle concentration V7 was 97. In case of the single-side incidence, since a reflecting plate is disposed on the side surface facing the light incidence surface to reuse light, the difference in efficiency is small even with different numbers of particles (particle concentrations).

For each of the three types of combined particle concentrations, illuminance distributions were calculated when a thickness error (unevenness) was added to the second layer while variously changing the ratio t_{cen}/T_{lg} between the thickness T_{lg} of the light guide plate 150 and the thickness t_{cen} at the center of the second layer 154 and the ratio t_{cen}/tₘᵢₙ between the smallest thickness tₘᵢₙ of the second layer 154 and the thickness t_{cen} at the center thereof.

Specifically, the thickness t_{cen} at the center of the second layer 154 was set to six types of 0.2 mm, 0.3 mm, 0.4 mm, 0.6 mm, 0.8 mm, and 0.975 mm (with largest thicknesses of 0.4 mm, 0.6 mm, 0.8 mm, 1.2 mm, 1.6 mm, and 1.95 mm, respectively) and the ratio t_{cen}/tₘᵢₙ between the smallest thickness tₘᵢₙ and the thickness t_{cen} at the center was set to three types of 5, 3, and 2.

The thickness error pattern added to the thickness of the second layer 154 was set to be equal to the error pattern illustrated in FIG. 6. FIG. 20 illustrates a graph indicating an ideal thickness of the second layer and the thickness when the error pattern was added thereto. In FIG. 20, the ideal thickness is indicated by a solid line, the error pattern is indicated by a dotted line, and the error-added thickness is indicated by a one-dot chained line.

In various combinations of the combined particle concentration, the ratio t_{cen}/T_{lg} between the thickness T_{lg} of the light guide plate 150 and the thickness t_{cen} at the center of the second layer 154, and the ratio t_{cen}/tₘᵢₙ between the smallest thickness tₘᵢₙ of the second layer 154 and the thickness t_{cen} at the center thereof, an illuminance distribution when the error pattern was added (actual distribution) and an illuminance distribution when the error pattern was not added (ideal distribution) were calculated and compared with each other.

Specifically, an average [%] of departure of the actual distribution from the ideal distribution was calculated. The calculation results are shown in Table 11.

Further, a value (the maximum value of departure) [%] obtained by adding the maximum value of departure in a direction in which the actual distribution becomes higher than the ideal distribution and the maximum value of departure in a direction in which the actual distribution becomes lower than the ideal distribution was calculated. The results are shown in Table 12. At the time of calculating the maximum value of departure, the actual distribution and the ideal distribution were compared with each other except the vicinity of the light incidence surface.

TABLE 11

| | Combined particle | t_{cen}/T_{lg} | | | | | |
|---|---|---|---|---|---|---|---|
| t_{cen}/tₘᵢₙ | concentration | 0.1 | 0.15 | 0.2 | 0.3 | 0.4 | 0.46 |
| 5 | V1 | — | 13.9 | 10.4 | 7.0 | 5.3 | 4.4 |
| | V4 | — | 9.3 | 7.0 | 4.7 | 3.5 | 2.9 |
| | V7 | — | 5.9 | 4.4 | 3.0 | 2.4 | 2.0 |
| 3 | V1 | — | — | — | — | — | — |
| | V4 | 15.1 | 10.1 | 7.6 | 5.3 | 3.2 | 3.1 |
| | V7 | 9.6 | 6.3 | 4.8 | 3.4 | 2.5 | 2.0 |
| 2 | V1 | — | — | — | — | — | — |
| | V4 | — | — | — | — | — | — |
| | V7 | 10.6 | 7.2 | 5.3 | 3.6 | 2.7 | 2.4 |

TABLE 12

| | Combined particle | t_{cen}/T_{lg} | | | | | |
|---|---|---|---|---|---|---|---|
| t_{cen}/tₘᵢₙ | concentration | 0.1 | 0.15 | 0.2 | 0.3 | 0.4 | 0.46 |
| 5 | V1 | — | 81.6 | 61.2 | 41.1 | 29.6 | 25.7 |
| | V4 | — | 46.8 | 35.4 | 23.7 | 18.0 | 16.0 |
| | V7 | — | 27.1 | 20.2 | 14.9 | 11.9 | 10.3 |
| 3 | V1 | — | — | — | — | — | — |
| | V4 | 75.3 | 50.4 | 39.2 | 26.2 | 17.4 | 17.5 |
| | V7 | 43.3 | 28.6 | 22.3 | 15.4 | 11.9 | 9.7 |
| 2 | V1 | — | — | — | — | — | — |
| | V4 | — | — | — | — | — | — |
| | V7 | 48.4 | 31.9 | 23.9 | 17.5 | 13.0 | 11.6 |

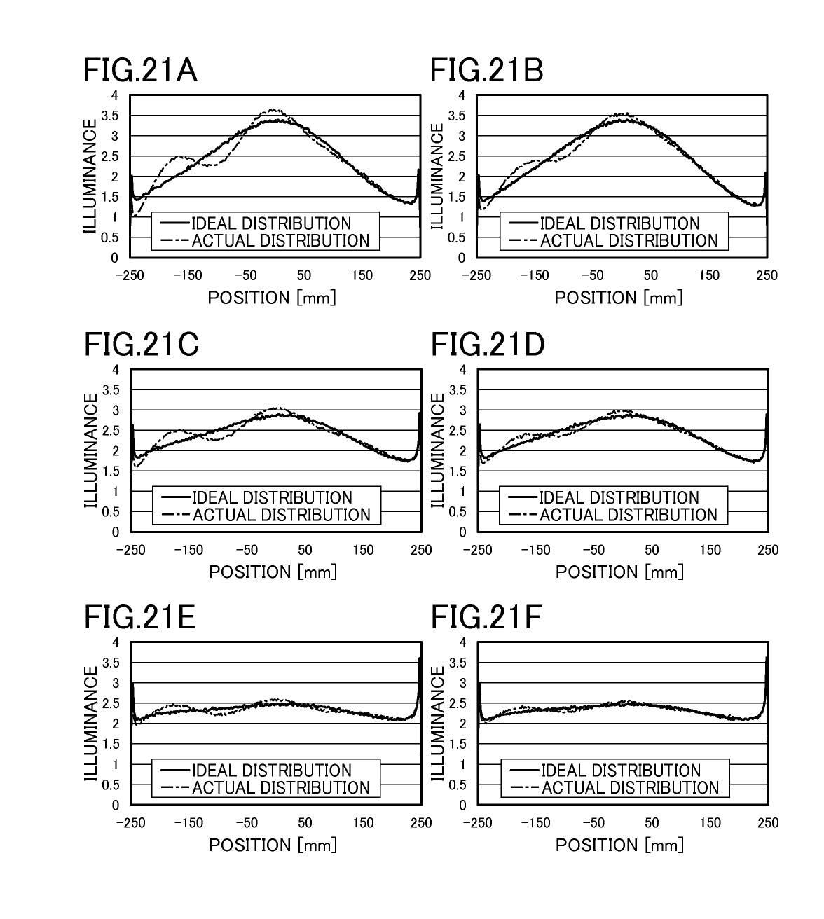

FIGS. 21A to 21F illustrate examples of the measurement result of the illuminance distribution of light exiting from the light exit surface of the light guide plate.

FIG. 21A illustrates an actual distribution (one-dot chained line) and an ideal distribution (solid line) of illuminance when t_{cen}/T_{lg} is set to 0.3, t_{cen}/tₘᵢₙ is set to 5, and the combined particle concentration is of type V1 (with efficiency of 100).

FIG. 21B illustrates an actual distribution (one-dot chained line) and an ideal distribution (solid line) of illuminance when t_{cen}/T_{lg} is set to 0.46, t_{cen}/tₘᵢₙ is set to 5, and the combined particle concentration is of type V1 (with efficiency of 100).

FIG. 21C illustrates an actual distribution (one-dot chained line) and an ideal distribution (solid line) of illuminance when t_{cen}/T_{lg} is set to 0.3, t_{cen}/tₘᵢₙ is set to 5, and the combined particle concentration is of type V4 (with efficiency of 99).

FIG. 21D illustrates an actual distribution (one-dot chained line) and an ideal distribution (solid line) of illuminance when t_{cen}/T_{lg} is set to 0.46, t_{cen}/tₘᵢₙ is set to 5, and the combined particle concentration is of type V4 (with efficiency of 99).

FIG. 21E illustrates an actual distribution (one-dot chained line) and an ideal distribution (solid line) of illuminance when t_{cen}/T_{lg} is set to 0.3, t_{cen}/tₘᵢₙ is set to 5, and the combined particle concentration is of type V7 (with efficiency of 97).

FIG. 21F illustrates an actual distribution (one-dot chained line) and an ideal distribution (solid line) of illuminance when t_{cen}/T_{lg} is set to 0.46, t_{cen}/tₘᵢₙ is set to 5, and the combined particle concentration is of type V7 (with efficiency of 97).

In even a thin light guide plate having a thickness of 4 mm or less and having a two-layer structure in which the variation of the actual thickness tends to increase due to the influence of thickness unevenness, it can be seen from Tables 11 and 12 and FIGS. 21A to 21F that the average of departure of the actual illuminance distribution from the ideal distribution can be set to 5% or less and the maximum value of departure can be set to 18% or less by setting t_{cen}/T_{lg} to be equal to or more than 0.3. That is, it can be seen that by setting t_{cen}/T_{lg} in the above range, the robustness can be improved, the light use efficiency can be improved, the influence of thickness unevenness (dimensional tolerance) of the light guide plate can be reduced, and even when the thickness of the light guide plate is uneven, the illuminance distribution does not depart greatly from a desired distribution and thus it is possible to prevent occurrence of unevenness. Therefore, it can be seen that in order to obtain a light guide plate capable of realizing a desired illuminance distribution, it is not necessary to reduce the dimensional tolerance and thus it is possible to stably and easily manufacture the light guide plate.

It can also be seen that the larger t_{cen}/tₘᵢₙ becomes, the smaller the average of departure and the maximum value of departure become and the smaller the illuminance unevenness becomes. It can also be seen that t_{cen}/tₘᵢₙ is preferably set to 2 or more, in that it is possible to reduce the influence of thickness unevenness, to stably emit light having high light use efficiency and small luminance unevenness, and thus to obtain a middle-high or bell-shaped brightness distribution.

The backlight unit using the light guide plate according to the present invention is not limited to this configuration, but a light source unit may be disposed so as to face the side surface on the short side of the light exit surface of the light guide plate in addition to two light source units. By increasing the number of light source units, it is possible to enhance the intensity of light exiting from the device.

Light may exit from the rear surface as well as the light exit surface.

The light guide plates in the shown examples include two layers having different particle concentrations of scattering particles, but the present invention is not limited to this configuration, and the light guide plates may include three or more layers having different particle concentrations of scattering particles.

### Example 4

In Example 4, light use efficiency when the size and the combined particle concentration (number of particles) of the light guide plate were changed was calculated using the light guide plate having the two-layered structure illustrated in FIG. 3B. The same configuration as in Example 1 was basically employed, except that the size and the combined particle concentration of the light guide plate were changed. That is, the distribution of the combined particle concentration was set such that a middle-high illuminance distribution in which the lowest illuminance in the vicinity of the light incidence surfaces was 75 when the highest illuminance at the center of outgoing light was assumed to be 100 was obtained. For each size, the light use efficiency was calculated as a relative value when the efficiency of the combination having the highest efficiency was assumed to be 100.

For each size, the relationship between the particle concentration and the average of departure [%] of the illuminance (average of departure from the ideal distribution) when an error pattern was added thereto was calculated.

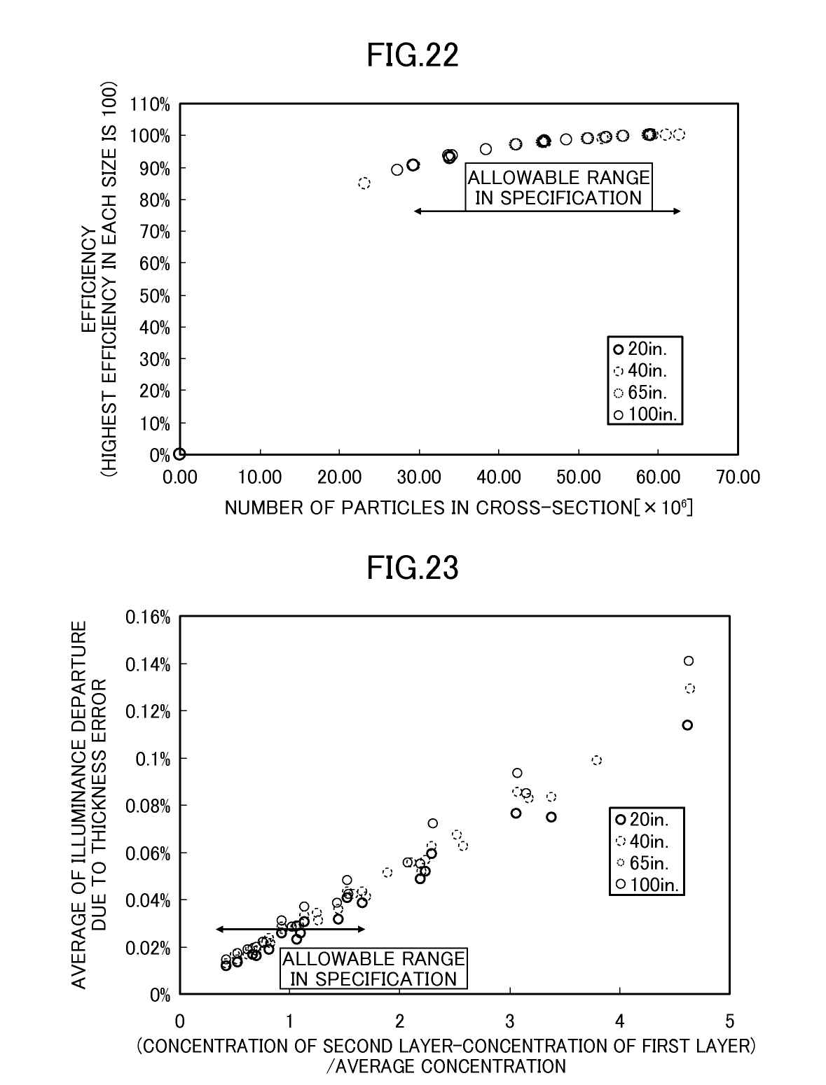

The calculation results of the relationship between the number of particles and the efficiency are illustrated in FIG. 22 and the calculation results of the relationship between the particle concentration and the average of departure of the illuminance are illustrated in FIG. 23.

In FIG. 22, the horizontal axis represents the number of particles in a cross-section [pieces], the vertical axis represents the efficiency [%], a case of 20 inches is indicated by a circle of a thick solid line, a case of 40 inches is indicated by a circle of a dotted line, a case of 65 inches is indicated by a circle of a short dotted line, and a case of 100 inches is indicated by a circle of a thin solid line. Here, the number of particles in a cross-section means the number of particles included in a volume per unit length (mm) in the length direction of a light incidence part.

In FIG. 23, the horizontal axis represents (concentration of second layer−concentration of first layer)/average concentration, the vertical axis represents the average of departure of illuminance, a case of 20 inches is indicated by a circle of a thick solid line, a case of 40 inches is indicated by a circle of a dotted line, a case of 65 inches is indicated by a circle of a short dotted line, and a case of 100 inches is indicated by a circle of a thin solid line.

It can be seen from FIG. 22 that in order to set the efficiency to 90% or more, the number of particles in a cross-section is preferably set to be in a range of 28.4×10⁶ to 62.6×10⁶. Further, it can be seen from FIG. 23 that in order to set the average of departure of illuminance to 0.04 or less, the value of (concentration of second layer−concentration of first layer)/average concentration is preferably set to be in a range of 0.42 to 1.7.

Next, by using the thickness T_{lg} of the light guide plate, the thickness t_{cen} at the center of the second layer, the smallest thickness tₘᵢₙ of the second layer, the radius of curvature R1 of the convex curved surface of the interface z, the radius of curvature R2 of the concave curved surface of the interface z, the particle concentration Npo of the first layer, and the particle concentration Npr of the second layer as design parameters, a range in which the number of particles in a cross-section is in a range of 28.4×10⁶ to 62.6×10⁶ and the value of (concentration of second layer−concentration of first layer)/average concentration is in a range of 0.42 to 1.7 was calculated for the light guide plate of each size.

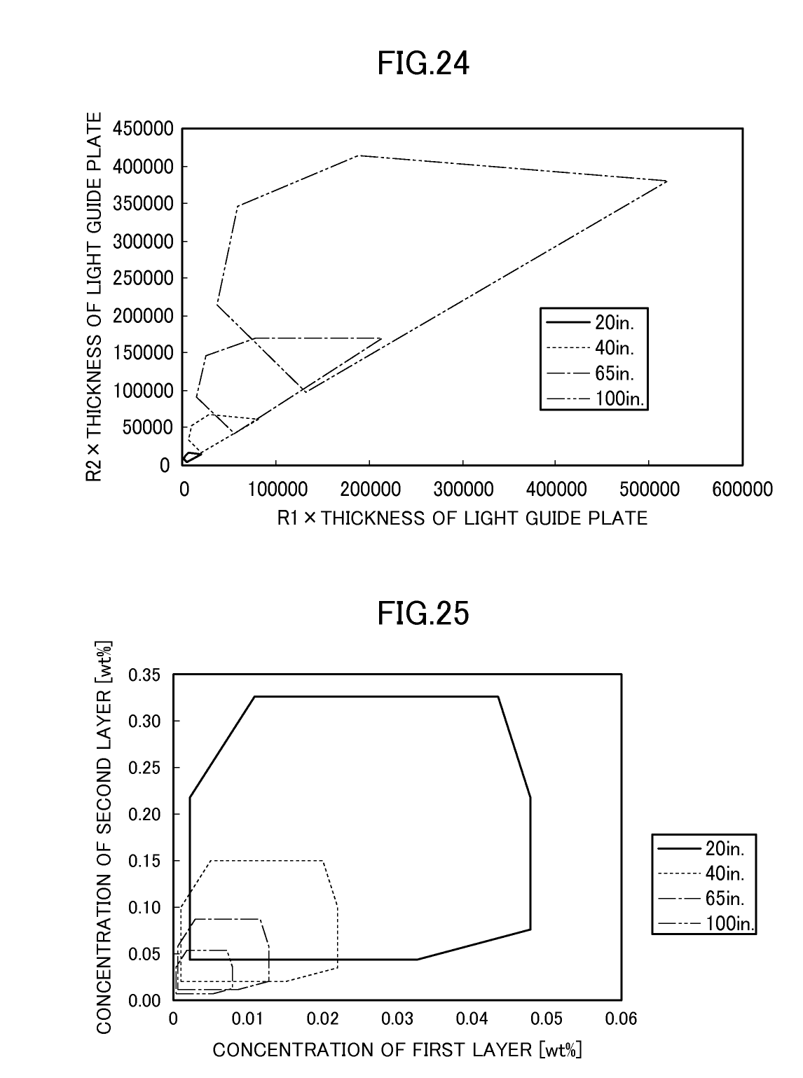

The ranges of t_{cen}/T_{lg} and t_{cen}/tₘᵢₙ out of the calculation results are shown in Table 13. A graph representing a preferable range of (Npo, Npr) with the concentration Npo of the first layer as the horizontal axis and with the concentration Npr of the second layer as the vertical axis is illustrated in FIG. 25, and coordinates indicating the range of (Npo, Npr) illustrated in FIG. 25 are illustrated in Table 14. A graph representing a preferable range of (R1·T_{lg}, R2·T_{lg}) with R1·T_{lg}, as the horizontal axis and with R2·T_{lg}, as the vertical axis is illustrated in FIG. 24. Coordinates indicating the range of (R1·T_{lg}, R2·T_{lg}) illustrated in FIG. 24 are shown in Table 15.

TABLE 13

| | 20 inches | | 40 inches | | 65 inches | | 100 inches | |
|---|---|---|---|---|---|---|---|---|
| | Lower | Upper | Lower | Upper | Lower | Upper | Lower | Upper |
| | limit | limit | limit | limit | limit | limit | limit | limit |
| t_{cen}/T_{lg} | 0.3 | 1 | 0.3 | 1 | 0.3 | 1 | 0.3 | 1 |
| t_{cen}/tₘᵢₙ | 2 | 20 | 2 | 20 | 2 | 20 | 2 | 20 |

TABLE 14

| | 20 inches | | 40 inches | | 65 inches | | 100 inches | |
|---|---|---|---|---|---|---|---|---|
| | Npo | Npr | Npo | Npr | Npo | Npr | Npo | Npr |
| P_{NP1} | 0.0022 | 0.043 | 0.001 | 0.020 | 0.00058 | 0.012 | 0.00036 | 0.0072 |
| P_{NP2} | 0.0330 | 0.043 | 0.015 | 0.020 | 0.00870 | 0.012 | 0.00540 | 0.0072 |
| P_{NP3} | 0.0480 | 0.076 | 0.022 | 0.035 | 0.01300 | 0.020 | 0.00790 | 0.0130 |
| P_{NP4} | 0.0480 | 0.220 | 0.022 | 0.100 | 0.01300 | 0.058 | 0.00790 | 0.0360 |
| P_{NP5} | 0.0430 | 0.330 | 0.020 | 0.150 | 0.01200 | 0.087 | 0.00720 | 0.0540 |
| P_{NP6} | 0.0110 | 0.330 | 0.005 | 0.150 | 0.00290 | 0.087 | 0.00180 | 0.0540 |
| P_{NP7} | 0.0022 | 0.220 | 0.001 | 0.100 | 0.00058 | 0.058 | 0.00036 | 0.0360 |

TABLE 15

| | 20 inches | | 40 inches | | 65 inches | | 100 inches | |
|---|---|---|---|---|---|---|---|---|
| | R1 · T_{lg} | R2 · T_{lg} | R1 · T_{lg} | R2 · T_{lg} | R1 · T_{lg} | R2 · T_{lg} | R1 · T_{lg} | R2 · T_{lg} |
| P_{R1} | 1700 | 8000 | 6000 | 34000 | 15500 | 90000 | 37000 | 210000 |
| P_{R2} | 5200 | 4000 | 21000 | 16000 | 55000 | 43000 | 130000 | 100000 |
| P_{R3} | 21000 | 15000 | 82000 | 62000 | 215000 | 170000 | 520000 | 380000 |
| P_{R4} | 7500 | 16500 | 29500 | 67000 | 78000 | 170000 | 190000 | 415000 |
| P_{R5} | 2800 | 13000 | 10000 | 54000 | 25000 | 145000 | 60000 | 350000 |

As shown in Table 13, by satisfying 0.3≦t_{cen}/T_{lg}≦1, it is possible to improve robustness. Accordingly, even a light guide plate having a large and thin shape can be less affected by the thickness unevenness and can stably emit light having high light use efficiency and small luminance unevenness, thereby obtaining a middle-high or bell-shaped brightness distribution.

By setting t_{cen}/tₘᵢₙ to 2 or more, it is possible to further reduce the influence of thickness unevenness and to further stably emit light having high light use efficiency and small luminance unevenness, thereby obtaining a middle-high or bell-shaped brightness distribution.

It is preferable that R1·T_{lg}, and R2·T_{lg} satisfy the range illustrated in FIG. 24 for each size. Accordingly, it is possible to further reduce the influence of the thickness unevenness and to further stably emit light having high light use efficiency and small luminance unevenness, thereby obtaining a middle-high or bell-shaped brightness distribution.

Here, it can be seen from FIG. 24 and Table 15 that R1·T_{lg}, and R2·T_{lg}, are proportional to the square of a size ratio. Accordingly, the coordinates indicating the preferable range of R1·T_{lg} and R2·T_{lg} can be expressed using the length L_{lg} of the light guide plate as follows: P_{R1}(6000·(L_{lg}/539)², 34000·(L_{lg}/539)²), P_{R2}(21000·(L_{lg}/539)², 16000·(L_{lg}/539)²), P_{R3}(82000·(L_{lg}/539)², 62000·(L_{lg}/539)²), P_{R4}(29500·(L_{lg}/539)², 67000·(L_{lg}/539)²), and P_{R5}(10000·(L_{lg}/539)², 54000·(L_{lg}/539)²). It is preferable that L_{lg}, R1, R2, and T_{lg} be in the range of P_{R1} to P_{R5}.

It is preferable that the particle concentrations Npo and Npr satisfy the range illustrated in FIG. 25 for each size.

Accordingly, it is possible to further reduce the influence of the thickness unevenness and to further stably emit light having high light use efficiency and small luminance unevenness, thereby obtaining a middle-high or bell-shaped brightness distribution.

Here, it can be seen from FIG. 25 and Table 14 that Npo and Npr are inversely proportional to the size ratio. Accordingly, the coordinates indicating the preferable range of Npo and Npr can be expressed using the length L_{lg} of the light guide plate as follows: P_{NP1}(0.001·(539/L_{lg}), 0.02·(539/L_{lg})), P_{NP2}(0.015·(539/L_{lg}), 0.02·(539/L_{lg})), P_{NP3}(0.022·(539/L_{lg}), 0.035·(539/L_{lg})), P_{NP4}(0.022·(539/L_{lg}), 0.1·(539/L_{lg})), P_{NP5}(0.02·(539/L_{lg}), 0.15·(539/L_{lg})), and P_{NP6}(0.005·(539/L_{lg}), 0.15·(539/L_{lg})), P_{NP7}(0.001·(539/L_{lg}), 0.1·(539/L_{lg})). It is preferable that L_{lg}, Npo, and Npr be in this range.

Next, the above-mentioned ranges will be described below in conjunction with examples.

In Example 4-1, a light guide plate in which a screen size was 40 inches, thickness at the center T_{cen}/thickness of light guide plate T_{lg} was set to 0.6, thickness at the center T_{cen}/smallest thickness tₘᵢₙ was set to 5, R1·T_{lg} and R2·T_{lg}, were set to 10000 and 54300, respectively, the particle concentration of the first layer was set to 0.005 [wt %], and the particle concentration of the second layer was set to 0.138 [wt %] was used. That is, the combinations of R1·T_{lg} and R2·T_{lg}, in Example 4-1 did not satisfy the above-mentioned preferable range. The light use efficiency in Example 4-1 was 100.

In Example 4-2, a light guide plate in which thickness at the center T_{cen}/thickness of light guide plate T_{lg} was set to 0.6, thickness at the center t_{cen}/smallest thickness tₘᵢₙ was set to 2, R1·T_{lg} and R2··T_{lg} were set to 34000 and 26000, respectively, the particle concentration of the first layer was set to 0.011 [wt %], and the particle concentration of the second layer was set to 0.042 [wt %] was used. That is, all the design parameters in Example 4-2 satisfied the above-mentioned preferable ranges. The light use efficiency in Example 4-2 was 92.

In Comparative Example 4-1, a light guide plate in which thickness at the center t_{cen}/thickness of light guide plate T_{lg} was set to 0.2, thickness at the center T_{cen}/smallest thickness tₘᵢₙ was set to 3, R1·T_{g} and R2·T_{lg} were set to 40000 and 88000, respectively, the particle concentration of the first layer was set to 0.010 [wt %], and the particle concentration of the second layer was set to 0.155 [wt %] was used. The light use efficiency in Comparative Example 4-1 was 98.

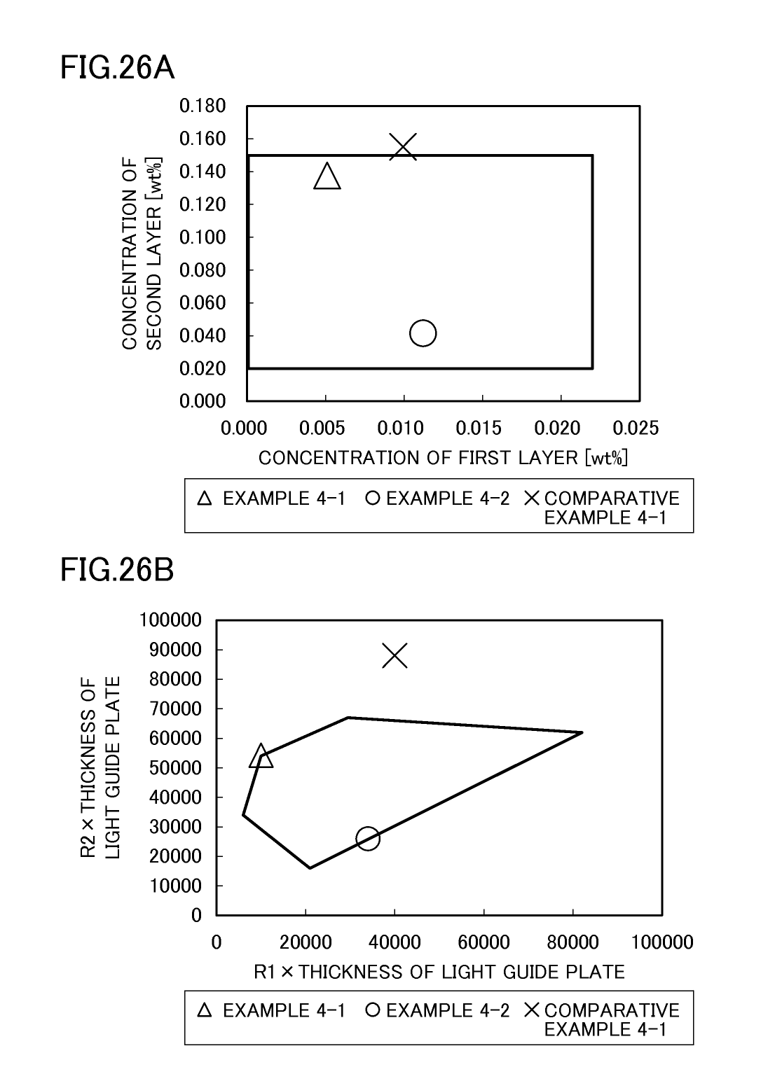

FIG. 26A illustrates a graph with the concentration of the first layer as the horizontal axis and with the concentration of the second layer as the vertical axis, and FIG. 26B illustrates a graph with R1·T_{lg} as the horizontal axis and with R2·T_{lg} as the vertical axis. In the graphs, the preferable range in case of 40 inches is indicated by a thick solid line, the position of Example 4-1 is indicated by a triangle, the position of Example 4-2 is indicated by a circle, and the position of Comparative Example 4-1 is indicated by an x mark.

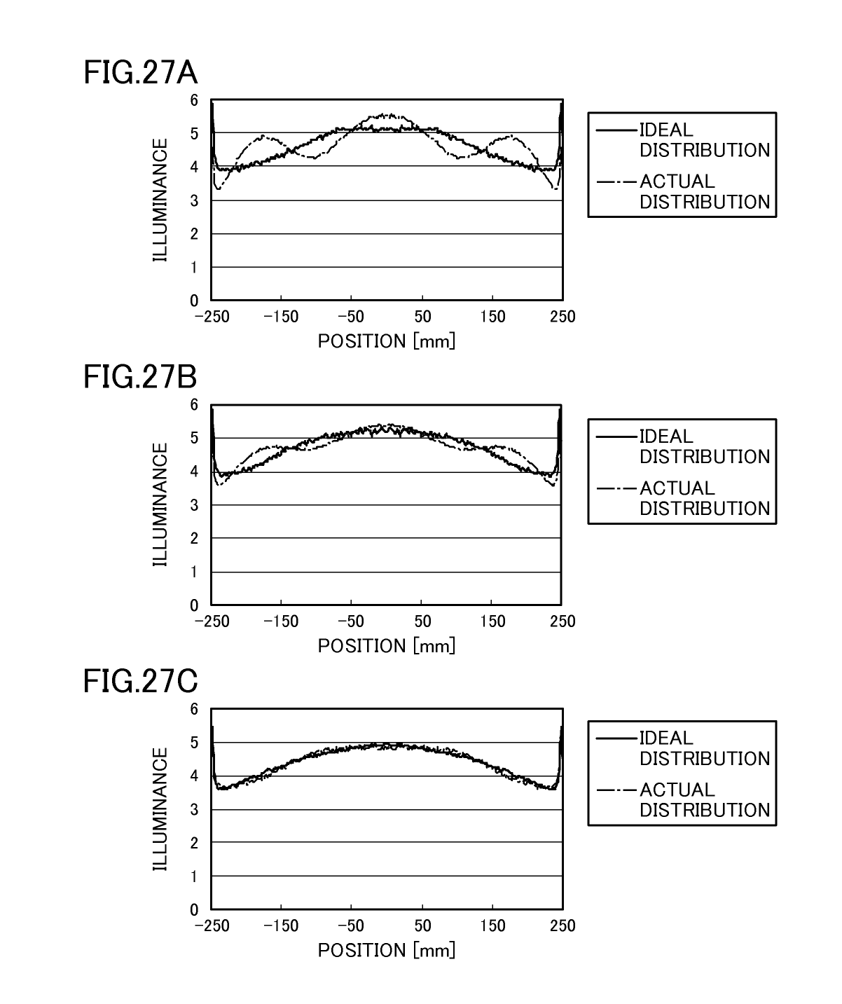

FIG. 27A illustrates illuminance distributions (ideal distribution and actual distribution) of light exiting from the light exit surface of the light guide plate of Comparative Example 4-1 having an error pattern added thereto, FIG. 27B illustrates illuminance distributions (ideal distribution and actual distribution) of light exiting from the light exit surface of the light guide plate of Example 4-1 having an error pattern added thereto, and FIG. 27C illustrates illuminance distributions (ideal distribution and actual distribution) of light exiting from the light exit surface of the light guide plate of Example 4-2 having an error pattern added thereto.

It can be seen from FIGS. 27A to 27C that in Comparative Example 4-1 in which t_{cen}/tₘᵢₙ is less than 0.3, large unevenness occurs in the actual distribution of illuminance to cause irregularity. On the contrary, in Examples 4-1 and 4-2 of the present invention, it can be seen that the unevenness in the actual distribution of illuminance is smaller, the influence of thickness error (dimensional tolerance) is smaller, and the robustness is higher, compared with Comparative Example 4-1. In Example 4-2, it can be seen that the unevenness in the actual distribution of illuminance is smaller and the influence of thickness error (dimensional tolerance) is smaller, compared with Example 4-1 in which the combination of R1·T_{lg} and R2·T_{lg} was not in the preferable range.

### Example 5

In Example 5, preferable ranges of the thickness T_{lg} of the light guide plate, the thickness T_{cen} at the center of the second layer, the smallest thickness tₘᵢₙ of the second layer, the radius of curvature R1 of the convex curved surface of the interface z, the radius of curvature R2 of the concave curved surface of the interface z, the particle concentration Npo of the first layer, and the particle concentration Npr of the second layer were calculated in the single-side incidence type light guide plate illustrated in FIG. 17A.

First, in order to set the average of departure of outgoing light to 5% or less and to set the maximum value of departure to 18% or less, it could be seen from the result of Example 3 that the value of (concentration Npr of second layer−concentration Npo of first layer)/average concentration had only to be set to 1.2 or less.

Next, by using the thickness T_{lg} of the light guide plate, the thickness T_{cen} at the center of the second layer, the smallest thickness tₘᵢₙ of the second layer, the radius of curvature R1 of the convex curved surface of the interface z, the radius of curvature R2 of the concave curved surface of the interface z, the particle concentration Npo of the first layer, and the particle concentration Npr of the second layer as design parameters, a range in which the combined particle concentration shows a middle-high illuminance distribution (illuminance distribution in which the lowest illuminance in the vicinity of the light incidence surface is in a range of 50 to 100 when the highest illuminance at the center of outgoing light is assumed to be 100), T_{lg}, t_{cen} and tₘᵢₙ satisfy the ranges of 0.3≦t_{cen}/T_{lg}≦1 and 2≦t_{cen}/tₘᵢₙ≦20, and the value of (concentration Npr of second layer−concentration Npo of first layer)/average concentration is equal to or less than 1.2 was calculated for the light guide plate of each size.

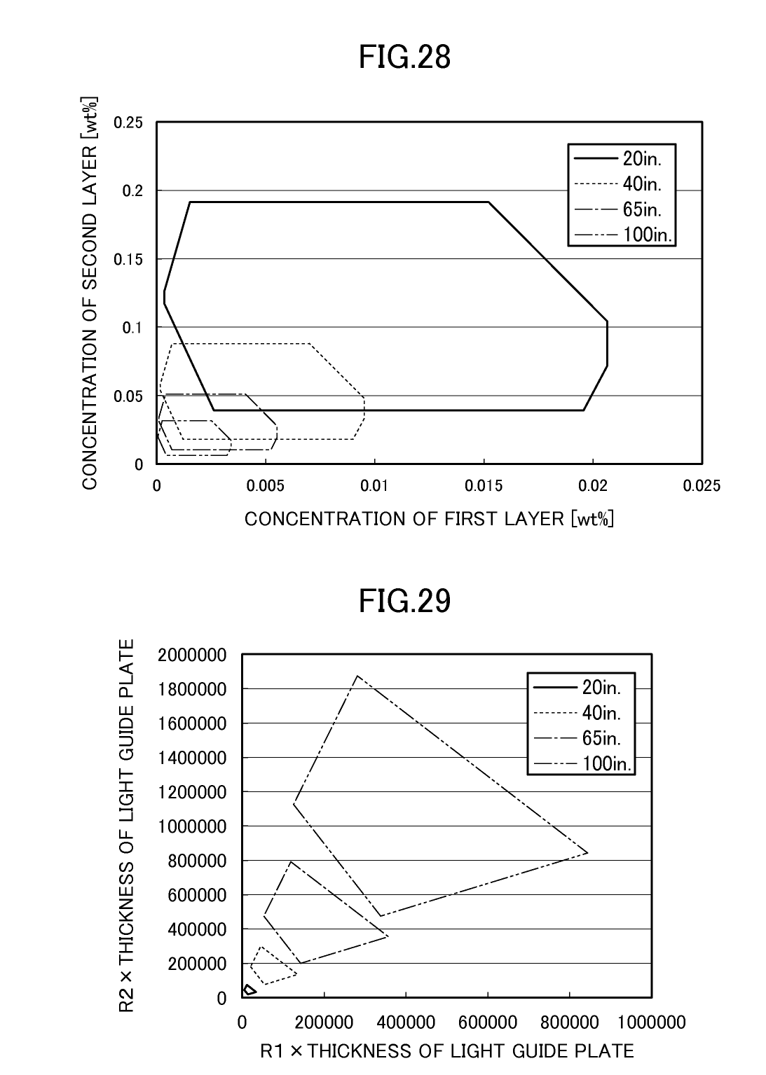

The ranges of t_{cen}/T_{lg} and t_{cen}/tₘᵢₙ out of the calculation results are shown in Table 16. A graph representing a preferable range of (Npo, Npr) with the concentration Npo of the first layer as the horizontal axis and with the concentration Npr of the second layer as the vertical axis is illustrated in FIG. 28, and coordinates indicating the range of (Npo, Npr) illustrated in FIG. 28 are illustrated in Table 17. A graph representing a preferable range of (R1·T_{lg}, R2·T_{lg}) with R1·T_{lg} as the horizontal axis and with R2·T_{lg} as the vertical axis is illustrated in FIG. 29. Coordinates indicating the range of (R1·T_{lg}, R2·T_{lg}) illustrated in FIG. 29 are shown in Table 18.

TABLE 16

| | 20 inches | | 40 inches | | 65 inches | | 100 inches | |
|---|---|---|---|---|---|---|---|---|
| | Lower limit | Upper limit | Lower limit | Upper limit | Lower limit | Upper limit | Lower limit | Upper limit |
| t_{cen}/T_{lg} | 0.3 | 0.52 | 0.3 | 0.52 | 0.3 | 0.52 | 0.3 | 0.52 |
| t_{cen}/tₘᵢₙ | 2 | 20 | 2 | 20 | 2 | 20 | 2 | 20 |

TABLE 17

| | 20 inches | | 40 inches | | 65 inches | | 100 inches | |
|---|---|---|---|---|---|---|---|---|
| | Npo | Npr | Npo | Npr | Npo | Npr | Npo | Npr |
| P_{NP1} | 0.00035 | 0.117 | 0.00016 | 0.054 | 0.000093 | 0.031 | 0.000057 | 0.0194 |
| P_{NP2} | 0.00261 | 0.039 | 0.00120 | 0.018 | 0.000697 | 0.010 | 0.000430 | 0.0065 |
| P_{NP3} | 0.01956 | 0.039 | 0.00900 | 0.018 | 0.005225 | 0.010 | 0.003225 | 0.0065 |
| P_{NP4} | 0.02065 | 0.072 | 0.00950 | 0.033 | 0.005515 | 0.019 | 0.003404 | 0.0118 |
| P_{NP5} | 0.02065 | 0.104 | 0.00950 | 0.048 | 0.005515 | 0.028 | 0.003404 | 0.0172 |
| P_{NP6} | 0.01521 | 0.191 | 0.00700 | 0.088 | 0.004064 | 0.051 | 0.002508 | 0.0315 |
| P_{NP7} | 0.00152 | 0.191 | 0.00070 | 0.088 | 0.000406 | 0.051 | 0.000251 | 0.0315 |
| P_{NP8} | 0.00035 | 0.126 | 0.00016 | 0.058 | 0.000093 | 0.034 | 0.000057 | 0.0208 |

TABLE 18

| | 20 inches | | 40 inches | | 65 inches | | 100 inches | |
|---|---|---|---|---|---|---|---|---|
| | R1 · T_{lg} | R2 · T_{lg} | R1 · T_{lg} | R2 · T_{lg} | R1 · T_{lg} | R2 · T_{lg} | R1 · T_{lg} | R2 · T_{lg} |
| P_{R1} | 5000 | 45000 | 20000 | 180000 | 52813 | 475313 | 125000 | 1125000 |
| P_{R2} | 13500 | 19000 | 54000 | 76000 | 142594 | 200688 | 337500 | 475000 |
| P_{R3} | 33750 | 33750 | 135000 | 135000 | 356484 | 356484 | 843750 | 843750 |
| P_{R4} | 11250 | 75000 | 45000 | 300000 | 118828 | 792188 | 281250 | 1875000 |

In the light guide plate of a single-side incidence type, it is preferable that the particle concentrations Npo and Npr satisfy the ranges illustrated in Table 17 and FIG. 28.

Accordingly, it is possible to further reduce the influence of the thickness unevenness and to further stably emit light having high light use efficiency and small luminance unevenness, thereby obtaining a middle-high or bell-shaped brightness distribution.

Here, it can be seen from FIG. 28 and Table 17 that Npo and Npr are inversely proportional to the size ratio. Accordingly, the coordinates indicating the preferable range of Npo and Npr can be expressed using the length L_{lg} of the light guide plate as follows: P_{NP1}(0.00016·(539/L_{lg}), 0.054·(539/L_{lg})), P_{NP2}(0.0012·(539/L_{lg}), 0.018·(539/L_{lg})), P_{NP3}(0.009·(539/L_{lg}), 0.018·(539/L_{lg})), P_{NP4}(0.0095·(539/L_{lg}), 0.033·(539/L_{lg})), P_{NP5}(0.0095·(539/L_{lg}), 0.048·(539/L_{lg})), P_{NP6}(0.007·(539/L_{lg}), 0.088·(539/L_{lg})), P_{NP7}(0.0007·(539/L_{lg}), 0.088·(539/L_{lg})), and P_{NP8}(0.00016·(539/L_{lg}), 0.058·(539/L_{lg})). It is preferable that L_{lg}, Npo, and Npr be in this range.

It is preferable that R1·T_{lg} and R2·T_{lg} satisfy the range illustrated in FIG. 29 for each size. Accordingly, it is possible to further reduce the influence of the thickness unevenness and to further stably emit light having high light use efficiency and small luminance unevenness, thereby obtaining a middle-high or bell-shaped brightness distribution.

Here, it can be seen from FIG. 29 and Table 16 that R1·T_{lg} and R2·T_{lg} are proportional to the square of a size ratio. Accordingly, the coordinates indicating the preferable range of R1·T_{lg} and R2·T_{lg}, can be expressed using the length L_{lg} of the light guide plate as follows: P_{R1}(20000·(L_{lg}/539)², 180000·(L_{lg}/539)²), P_{R2}(54000·(L_{lg}/539)², 76000·(L_{lg}/539)²), P_{R3}(135000·(L_{lg}/539)², 135000·(L_{lg}/539)²), and P_{R4}(4500·(L_{lg}/539)², 300000·(L_{lg}/539)²). It is preferable that L_{lg}, R1, R2, and T_{lg} be in the range of P_{R1} to P_{R4}.

While the light guide plate according to the present invention has been described above in detail, the present invention is not limited to the above-mentioned embodiments but may be improved or modified in various forms without departing from the gist of the present invention.

What is claimed is:

1. A light guide plate comprising: a rectangular light exit surface; a light incidence surface that is disposed on an end face of the light exit surface and on which light traveling in a direction substantially parallel to the light exit surface is incident; a rear surface that is opposite to the light exit surface; scattering particles that are dispersed therein; and two layers that overlap each other in a direction perpendicular to the light exit surface,
wherein the two layers are a first layer disposed on a light exit surface side and a second layer disposed on a rear surface side and having a higher particle concentration of the scattering particles than that of the first layer,
wherein thicknesses of the two layers in the direction substantially perpendicular to the light exit surface vary in a direction perpendicular to the light incidence surface to change a combined particle concentration, and
wherein when a thickness of the light guide plate in the direction perpendicular to the light exit surface is defined as T_{lg} and the thickness at a center of the second layer is defined as t_{cen}, conditional expressions of 0.3 mm≦T_{lg}≦4 mm and 0.3≦t_{cen}/T_{lg}≦1 are satisfied.

2. The light guide plate according to claim 1, wherein in the direction perpendicular to the light incidence surface, the light guide plate has a region in which the thickness of the second layer gradually decreases from the center thereof toward the light incidence surface, and when a smallest thickness of the second layer in the region is defined as tₘᵢₙ, a relationship of 2≦t_{cen}/tₘᵢₙ≦10 is satisfied.

3. The light guide plate according to claim 1, wherein in the direction perpendicular to the light incidence surface, the light guide plate has a region in which the thickness of the second layer decreases up to a smallest thickness tₘᵢₙ and increases as it goes far away from the light incidence surface.

4. The light guide plate according to claim 3, further comprising an additional light incidence surface that is opposite to the light incidence surface,
wherein in the direction perpendicular to two light incidence surfaces including the light incidence surface and the additional light incidence surface, the thickness of the second layer is a largest thickness at the center thereof, and the thickness of the second layer smoothly varies so as to decrease up to the smallest thickness tₘᵢₙ and to increase as it goes close to each of the two light incidence surfaces from the center.

5. The light guide plate according to claim 3, further comprising an additional light incidence surface that is opposite to the light incidence surface,
wherein in the direction perpendicular to two light incidence surfaces including the light incidence surface and the additional light incidence surface, the thickness of the second layer is a largest thickness at the center thereof, and the thickness of the second layer smoothly varies so as to decrease up to the smallest thickness tₘᵢₙ and to increase as it goes close to each of the two light incidence surfaces from the center, and then decreases.

6. The light guide plate according to claim 4, wherein an interface between the first layer and the second layer has a region including two curved surfaces, which are concave to the light exit surface, on each side of the two light incidence surfaces and a curved surface which is smoothly connected to the two concave curved surfaces between the two concave curved surfaces and which is convex to the light exit surface.

7. The light guide plate according to claim 5, wherein an interface between the first layer and the second layer has a region including two curved surfaces, which are concave to the light exit surface, on each side of the two light incidence surfaces and a curved surface which is smoothly connected to the two concave curved surfaces between the two concave curved surfaces and which is convex to the light exit surface.

8. The light guide plate according to claim 6, wherein when a radius of curvature of the convex curved surface is defined as R1, a radius of curvature of the concave curved surfaces is defined as R2, and a distance between the two light incidence surfaces is defined as L_{lg}, T_{lg}·R1 and T_{lg}·R2 are located in a range surrounded with five points P_{R1}(6000·(L_{lg}/539)², 34000·(L_{lg}/539)²), P_{R2}(21000·(L_{lg}/539)², 16000·(L_{lg}/539)²), P_{R3}(82000·(L_{lg}/539)², 62000·(L_{lg}/539)²), P_{R4}(29500·(L_{lg}/539)², 67000·(L_{lg}/539)²), and P_{R5}(10000·(L_{lg}/539)², 54000·(L_{lg}/539)²) in a graph with T_{lg}·R1 taken as a horizontal axis and T_{lg}·R2 taken as a vertical axis.

9. The light guide plate according to claim 4, wherein when the particle concentration of the first layer is defined as Npo and the particle concentration of the second layer is defined as Npr, conditional expressions of 0.0004 wt %≦Npo≦0.044 wt % and 0.008 wt %≦Npr≦0.3 wt % are satisfied.

10. The light guide plate according to claim 4, wherein when the particle concentration of the first layer is defined as Npo, the particle concentration of the second layer is defined as Npr, and a distance between the two light incidence surfaces is defined as L_{lg}, Npo and Npr are located in a range surrounded with seven points P_{NP1}(0.001·(539/L_{lg}), 0.02·(539/L_{lg})), P_{NP2}(0.015·(539/L_{lg}), 0.02·(539/L_{lg})), P_{NP3}(0.022·(539/L_{lg}), 0.035·(539/L_{lg})), P_{NP4}(0.022·(539/L_{lg}), 0.1·(539/L_{lg})), P_{NP5}(0.02·(539/L_{lg}), 0.15·(539/L_{lg})), and P_{NP6}(0.005·(539/L_{lg}), 0.15·(539/L_{lg})), P_{NP7}(0.001·(539/L_{lg}), 0.1·(539/L_{lg})) in a graph with Npo taken as a horizontal axis and Npr taken as a vertical axis.

11. The light guide plate according to claim 3, wherein in the direction perpendicular to the light incidence surface, the thickness of the second layer smoothly varies so as to decrease up to the smallest thickness tₘᵢₙ, to increase up to a largest thickness, and to decrease again as it goes far away from the light incidence surface.

12. The light guide plate according to claim 3, wherein in the direction perpendicular to the light incidence surface, the thickness of the second layer smoothly varies so as to decrease up to the smallest thickness tₘᵢₙ, to increase up to a largest thickness, and to maintain the largest thickness as it goes far away from the light incidence surface.

13. The light guide plate according to claim 3, wherein in the direction perpendicular to the light incidence surface, the thickness of the second layer continuously varies so as to once increase, to decrease up to the smallest thickness tₘᵢₙ, to increase up to a largest thickness and to decrease again as it goes far away from the light incidence surface.

14. The light guide plate according to claim 3, wherein in the direction perpendicular to the light incidence surface, the thickness of the second layer continuously varies so as to once increase, to decrease up to the smallest thickness tₘᵢₙ, to increase again up to a largest thickness, and to maintain the largest thickness as it goes far away from the light incidence surface.

15. The light guide plate according to claim 11, wherein in the direction perpendicular to the light incidence surface, an interface between the first layer and the second layer in a region from a position at which the second layer has the smallest thickness tₘᵢₙ to a position at which the second layer has the largest thickness includes a curved surface which is concave to the light exit surface and a curved surface which is smoothly connected to the concave curved surface and which is convex to the light exit surface.

16. The light guide plate according to claim 15, wherein when a radius of curvature of the convex curved surface is defined as R1, a radius of curvature of the concave curved surface is defined as R2, and a distance between the light incidence surface and a surface opposite to the light incidence surface is defined as L_{lg}, T_{lg}·R1 and T_{lg}·R2 are located in a range surrounded with four points P_{R1}(20000·(L_{lg}/539)², 180000·(L_{lg}/539)²), P_{R2}(54000·(L_{lg}/539)², 76000·(L_{lg}/539)²), P_{R3}(135000·(L_{lg}/539)², 135000·(L_{lg}/539)²), and P_{R4}(45000·(L_{lg}/539)², 300000·(L_{lg}/539)²) in a graph with T_{lg}·R1 taken as a horizontal axis and T_{lg}·R2 taken as a vertical axis.

17. The light guide plate according to claim 11, wherein when the particle concentration of the first layer is defined as Npo and the particle concentration of the second layer is defined as Npr, conditional expressions of 0.0000573 wt %≦Npo≦0.021 wt % and 0.0064 wt %≦Npr≦0.19 wt % are satisfied.

18. The light guide plate according to claim 11, wherein when a distance between the light incidence surface and a surface opposite to the light incidence surface is defined as L_{lg}, the particle concentration of the first layer is defined as Npo, and the particle concentration of the second layer is defined as Npr, Npo and Npr are located in a range surrounded with eight points P_{NP1}(0.000016·(539/L_{lg}), 0.054·(539/L_{lg})), P_{NP2}(0.0012·(539/L_{lg}), 0.018·(539/L_{lg})), P_{NP3}(0.009·(539/L_{lg}), 0.018·(539/L_{lg})), P_{NP4}(0.0095·(539/L_{lg}), 0.033·(539/L_{lg})), P_{NP5}(0.0095·(539/L_{lg}), 0.048·(539/L_{lg})), P_{NP6}(0.007·(539/L_{lg}), 0.088·(539/L_{lg})), P_{NP7}(0.0007·(539/L_{lg}), 0.088·(539/L_{lg})), and P_{NP8}(0.00016·(539/L_{lg}), 0.058·(539/L_{lg})) in a graph with Npo taken as a horizontal axis and Npr taken as a vertical axis.

19. The light guide plate according to claim 1, wherein the light exit surface is a curved surface which is convex to the rear surface.
